(19) United States
(12) Patent Application Publication
(10) Pub. No.: US 2016/0251956 A1
(43) Pub. Date: Sep. 1, 2016

(54) Power Cable Based Multi-Sensor Unit Signal Transmission

(71) Applicant: SCHLUMBERGER TECHNOLOGY CORPORATION, Sugar Land, TX (US)

(72) Inventors: Luis Parra, Houston, TX (US); Roderick Ian Mackay, London (GB); Dudi Abdullah Rendusara, Singapore (SG)

(21) Appl. No.: 15/033,592

(22) PCT Filed: Oct. 28, 2014
(86) PCT No.: PCT/US2014/062491

§ 371 Date: Apr. 29, 2016

Related U.S. Application Data
(60) Provisional application No. 61/897,155, filed on Oct. 29, 2013.

(51) Int. Cl. E21B 47/12; E21B 47/00; G08B 21/18; G08C 15/02; G08C 15/06; E21B 43/12; E21B 47/06

(52) U.S. Cl. CPC E21B 47/12; E21B 43/128; E21B 47/0007; E21B 47/06; E21B 47/065; G08C 15/02; G08C 15/06; G08B 21/182; E21B 43/2406

(57) ABSTRACT

A system can include a first electric submersible pump that includes an electric motor with a wye point and a sensor unit coupled to the wye point; a second electric submersible pump that includes an electric motor with a wye point and a sensor unit coupled ot the wye point; a multiphase power cable operatively coupled to the electric motor of the first electric submersible pump and operatively coupled to the electric motor of the second electric submersible pump; and communication circuitry that includes a choke operatively coupled to the multiphase power cable that receives signals transmitted by the sensor unit of the first electric submersible pump and that receives signals transmitted by the sensor unit of the second electric submersible pump.

### RELATED APPLICATION

This application claims priority to and the benefit of a U.S. Provisional Application having Ser. No. 61/897,155, filed 29 Oct. 2013, which is incorporated by reference herein.

### BACKGROUND

An electric submersible pump (ESP) system can include a pump driven by an electric motor. As an example, an ESP system may be deployed in a well, for example, to pump fluid.

### SUMMARY

A system can include a first electric submersible pump that includes an electric motor with a wye point and a sensor unit coupled to the wye point; a second electric submersible pump that includes an electric motor with a wye point and a sensor unit coupled to the wye point; a multiphase power cable operatively coupled to the electric motor of the first electric submersible pump and operatively coupled to the electric motor of the second electric submersible pump; and communication circuitry that can include a choke operatively coupled to the multiphase power cable that receives signals transmitted by the sensor unit of the first electric submersible pump and that receives signals transmitted by the sensor unit of the second electric submersible pump. A method can include transmitting a signal from a first ESP via a wye point of an electric motor to a multiphase power cable; transmitting a signal from a second ESP via a wye point of an electric motor to the multiphase power cable; and receiving the transmitted signals via a choke operatively coupled to the multiphase power cable. A sensor unit can include a wye point interface; and multiplexing circuitry operatively coupled to the wye point interface where the multiplexing circuitry multiplexes sensor signals according to a multi-sensor unit multiplexing scheme. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in geologic environments;

FIG. 2 illustrates an example of an electric submersible pump system;

FIG. 3 illustrates examples of equipment;

FIG. 4 illustrates an example of a system that includes a motor;

FIG. 5 illustrates an example of a system that includes two downhole ESP power cables joined at a surface junction box to a common power cable and an example of a system that includes an ESP power cable that extends downhole;

FIG. 6 illustrates an example of a method and examples of techniques for multiplexing information;

FIG. 7 illustrates an example of a system that includes a multiphase power cable operatively coupled to at least two electric motors;

FIG. 8 illustrates an example of frequency based transmission circuitry and an example of frequency based reception circuitry;

FIG. 9 illustrates an example of time based transmission circuitry and an example of time based reception circuitry;

FIG. 10 illustrates an example of a system, an example of a scenario and an example of a method;

FIG. 11 illustrates an example of a system and an example of circuitry;

FIG. 12 illustrates an example of an arrangement of components and an example of circuitry;

FIG. 13 illustrates an example of a system;

FIG. 14 illustrates examples of an architectures and an example of an interface card;

FIG. 15 illustrates an example of a master and slave arrangement of circuitry;

FIG. 16 illustrates an example of a method;

FIG. 17 illustrates an example of a system and examples of data plots;

FIG. 18 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

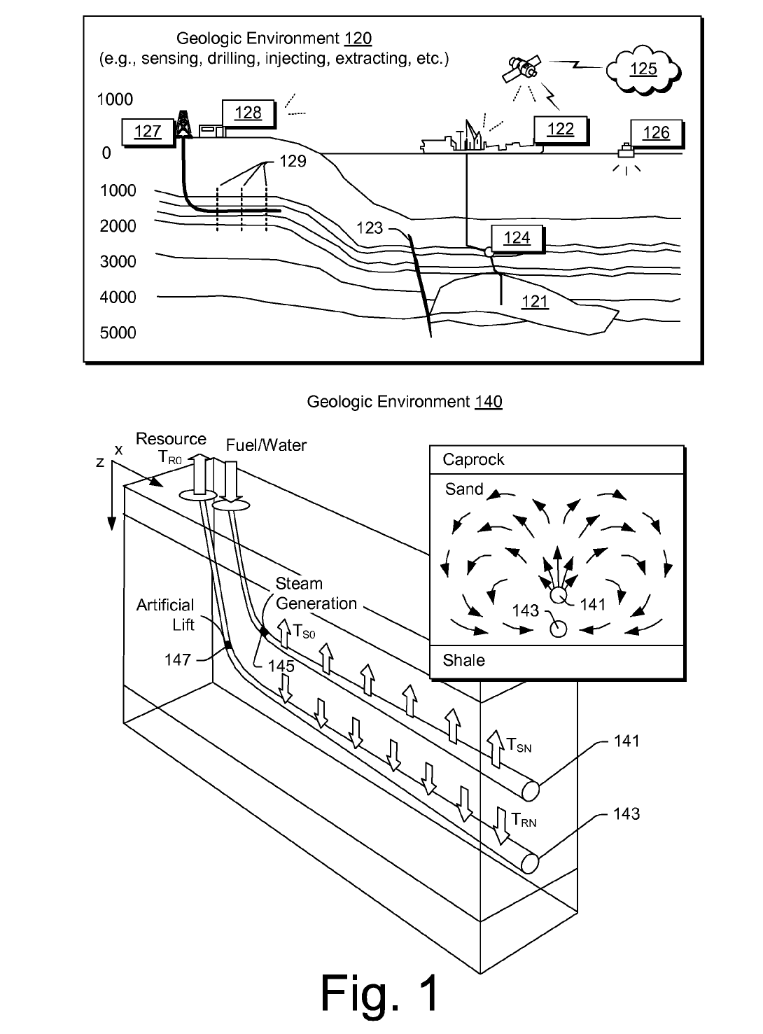

FIG. 1 shows examples of geologic environments 120 and 140. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, etc.

As to the geologic environment 140, as shown in FIG. 1, it includes two wells 141 and 143 (e.g., bores), which may be, for example, disposed at least partially in a layer such as a sand layer disposed between caprock and shale. As an example, the geologic environment 140 may be outfitted with equipment 145, which may be, for example, steam assisted gravity drainage (SAGD) equipment for injecting steam for enhancing extraction of a resource from a reservoir. SAGD is a technique that involves subterranean delivery of steam to enhance flow of heavy oil, bitumen, etc. SAGD can be applied for Enhanced Oil Recovery (EOR), which is also known as tertiary recovery because it changes properties of oil in situ.

As an example, a SAGD operation in the geologic environment 140 may use the well 141 for steam-injection and the well 143 for resource production. In such an example, the equipment 145 may be a downhole steam generator and the equipment 147 may be an electric submersible pump (e.g., an ESP).

As illustrated in a cross-sectional view of FIG. 1, steam injected via the well 141 may rise in a subterranean portion of the geologic environment and transfer heat to a desirable resource such as heavy oil. In turn, as the resource is heated, its viscosity decreases, allowing it to flow more readily to the well 143 (e.g., a resource production well). In such an example, equipment 147 (e.g., an ESP) may then assist with lifting the resource in the well 143 to, for example, a surface facility (e.g., via a wellhead, etc.). As an example, where a production well includes artificial lift equipment such as an ESP, operation of such equipment may be impacted by the presence of condensed steam (e.g., water in addition to a desired resource). In such an example, an ESP may experience conditions that may depend in part on operation of other equipment (e.g., steam injection, operation of another ESP, etc.).

Conditions in a geologic environment may be transient and/or persistent. Where equipment is placed within a geologic environment, longevity of the equipment can depend on characteristics of the environment and, for example, duration of use of the equipment as well as function of the equipment. Where equipment is to endure in an environment over an extended period of time, uncertainty may arise in one or more factors that could impact integrity or expected lifetime of the equipment. As an example, where a period of time may be of the order of decades, equipment that is intended to last for such a period of time may be constructed to endure conditions imposed thereon, whether imposed by an environment or environments and/or one or more functions of the equipment itself.

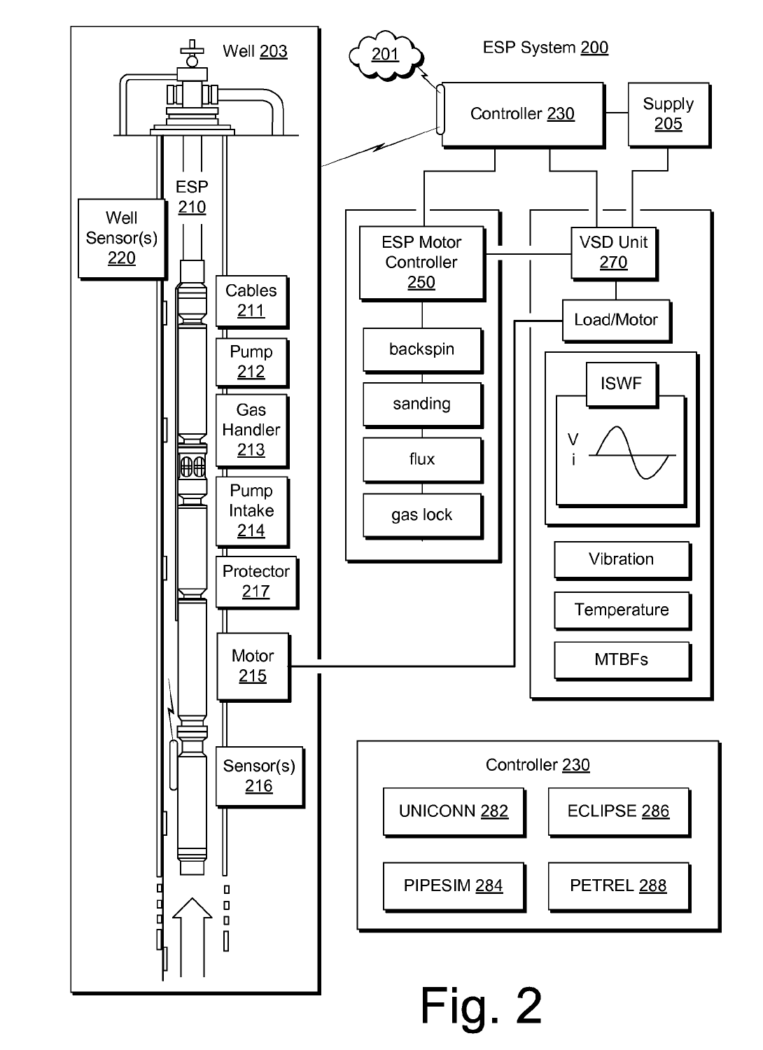

FIG. 2 shows an example of an ESP system 200 that includes an ESP 210 as an example of equipment that may be placed in a geologic environment. As an example, an ESP may be expected to function in an environment over an extended period of time (e.g., optionally of the order of years). As an example, commercially available ESPs (such as the REDA™ ESPs marketed by Schlumberger Limited, Houston, Tex.) may find use in applications that call pump rates of the order of a thousand barrels per day or more. As an example, an ESP may be disposed in a bore to a desired distance (e.g., depth, etc.). As an example, an ESP may be disposed in a bore at a distance, for example, of more than a thousand meters.

In the example of FIG. 2, the ESP system 200 includes a network 201, a well 203 disposed in a geologic environment (e.g., with surface equipment, etc.), a power supply 205, the ESP 210, a controller 230, a motor controller 250 and a VSD unit 270. The power supply 205 may receive power from a power grid, an onsite generator (e.g., natural gas driven turbine), or other source. The power supply 205 may supply a voltage, for example, of about 4.16 kV.

As shown, the well 203 includes a wellhead that can include a choke (e.g., a choke valve). For example, the well 203 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

As to the ESP 210, it is shown as including cables 211 (e.g., or a cable), a pump 212, gas handling features 213, a pump intake 214, a motor 215, one or more sensors 216 (e.g., temperature, pressure, strain, current leakage, vibration, etc.) and optionally a protector 217.

As an example, an ESP may include a REDA™ Hotline high-temperature ESP motor. Such a motor may be suitable for implementation in a thermal recovery heavy oil production system, such as, for example, SAGD system or other steam-flooding system.

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation.

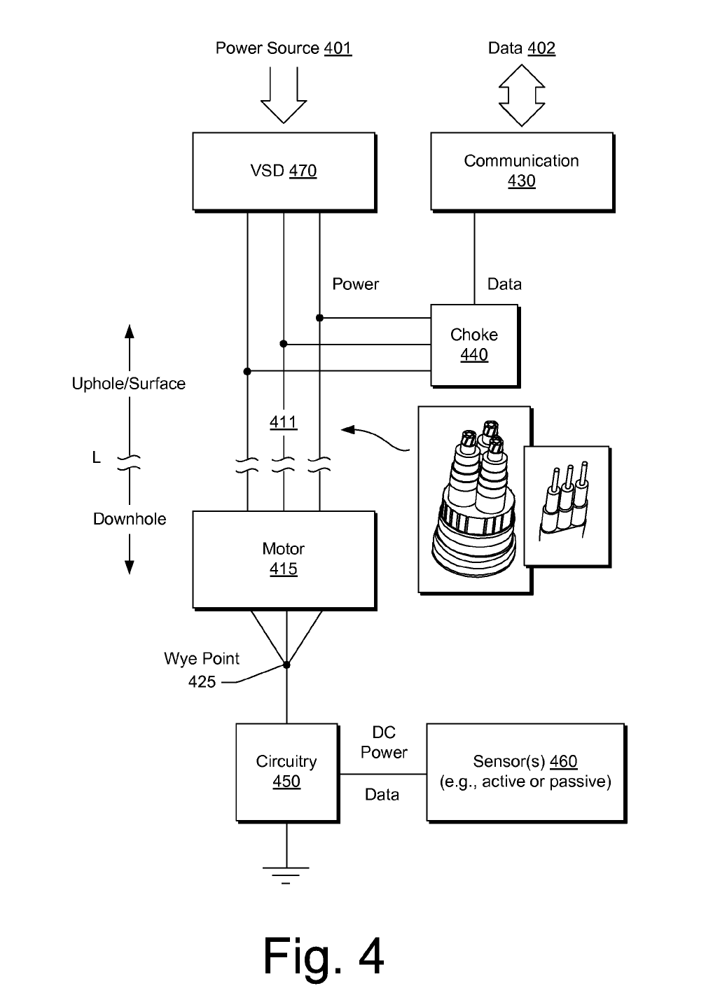

As an example, the one or more sensors 216 of the ESP 210 may be part of a digital downhole monitoring system. For example, consider the commercially available PHOENIX™ Multisensor xt150 system marketed by Schlumberger Limited (Houston, Tex.). A monitoring system may include a base unit that operatively couples to an ESP motor (see, e.g., the motor 215), for example, directly, via a motor-base crossover, etc. As an example, such a base unit (e.g., base gauge) may measure intake pressure, intake temperature, motor oil temperature, motor winding temperature, vibration, currently leakage, etc. As explained with respect to FIG. 4, a base unit may transmit information via a power cable that provides power to an ESP motor and may receive power via such a cable as well.

As an example, a remote unit may be provided that may be located at a pump discharge (e.g., located at an end opposite the pump intake 214). As an example, a base unit and a remote unit may, in combination, measure intake and discharge pressures across a pump (see, e.g., the pump 212), for example, for analysis of a pump curve. As an example, alarms may be set for one or more parameters (e.g., measurements, parameters based on measurements, etc.).

Where a system includes a base unit and a remote unit, such as those of the PHOENIX™ Multisensor x150 system, the units may be linked via wires. Such an arrangement can provide power from the base unit to the remote unit and can allow for communication between the base unit and the remote unit (e.g., at least transmission of information from the remote unit to the base unit). As an example, a remote unit is powered via a wired interface to a base unit such that one or more sensors of the remote unit can sense physical phenomena. In such an example, the remote unit can then transmit sensed information to the base unit, which, in turn, may transmit such information to a surface unit via a power cable configured to provide power to an ESP motor.

In the example of FIG. 2, the well 203 may include one or more well sensors 220, for example, such as the commercially available OPTICLINE™ sensors or WELLWATCHER BRITEBLUE™ sensors marketed by Schlumberger Limited (Houston, Tex.). Such sensors are fiber-optic based and can provide for real time sensing of temperature, for example, in SAGD or other operations. As shown in the example of FIG. 1, a well can include a relatively horizontal portion. Such a portion may collect heated heavy oil responsive to steam injection. Measurements of temperature along the length of the well can provide for feedback, for example, to understand conditions downhole of an ESP. Well sensors may extend into a well, optionally beyond a position of an ESP.

In the example of FIG. 2, the controller 230 can include one or more interfaces, for example, for receipt, transmission or receipt and transmission of information with the motor controller 250, a VSD unit 270, the power supply 205 (e.g., a gas fueled turbine generator, a power company, etc.), the network 201, equipment in the well 203, equipment in another well, etc.

As shown in FIG. 2, the controller 230 may include or provide access to one or more modules or frameworks. Further, the controller 230 may include features of an ESP motor controller and optionally supplant the ESP motor controller 250. For example, the controller 230 may include the UNICONN™ motor controller 282 marketed by Schlumberger Limited (Houston, Tex.). In the example of FIG. 2, the controller 230 may access one or more of the PIPESIM™ framework 284, the ECLIPSE™ framework 286 marketed by Schlumberger Limited (Houston, Tex.) and the PETREL™ framework 288 marketed by Schlumberger Limited (Houston, Tex.) (e.g., and optionally the OCEAN™ framework marketed by Schlumberger Limited (Houston, Tex.)).

In the example of FIG. 2, the motor controller 250 may be a commercially available motor controller such as the UNICONN™ motor controller. As an example, the UNICONN™ motor controller can interface with fixed speed drive (FSD) controllers or a VSD unit, for example, such as the VSD unit 270. The UNICONN™ motor controller can connect to a SCADA system, the ESPWATCHER™ surveillance system (Schlumberger Limited, Houston Tex.), LIFTWATCHER™ system (Schlumberger Limited, Houston Tex.), etc. The UNICONN™ motor controller can perform some control and data acquisition tasks for ESPs, surface pumps or other monitored wells. As an example, the UNICONN™ motor controller can interface with the aforementioned PHOENIX™ monitoring system, for example, to access pressure, temperature and vibration data and various protection parameters as well as to provide direct current power to downhole sensors. As an example, a system may include one or more interface cards that include circuitry that can interface with a data line or lines associated with a monitoring system, sensor unit (e.g., a gauge), etc. For example, a system may include one or more PHOENIX™ interface cards (PICs), which may, for example, provide current (e.g., direct current) to a multiphase power cable that can be received by a sensor unit operatively coupled to a wye point of an electric motor.

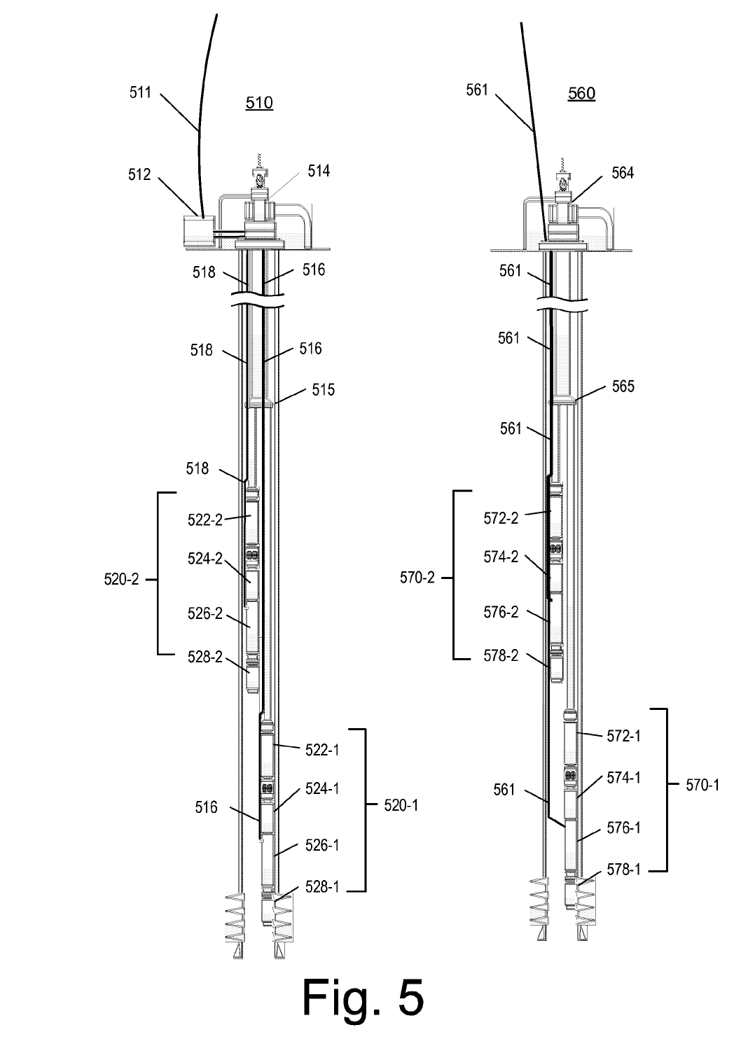

As an example, a system may include multiple electric submersible pumps (ESPs) that are powered via a single multiphase power cable and where each of the multiple ESPs may include a sensor unit operatively coupled to a wye points of a respective one of the electric motors of the ESPs (see, e.g., the systems 510 and 560 of FIG. 5, etc.). In such an example, a controller may include circuitry that can control a plurality of ESPs (e.g., speed, etc.). As an example, a system may include multiple interface cards (e.g., PICs, etc.) that are operatively coupled, at least in part via a multiphase power cable, to multiple sensor units (e.g., PHOENIX™ sensor units, etc.). As an example, such multiple sensor units may include circuitry (e.g., as one or more of hardware, software, firmware) that can transmit signals according to one or more multiplexing techniques (e.g., frequency based and/or time based). As an example, demultiplexing circuitry (e.g., as one or more of hardware, software, firmware) that can demultiplex multiplexed signals may be included in an interface card such as a PIC or, for example, operatively coupled to an interface card or interface cards (e.g., to demultiplex signals and direct appropriate signals to appropriate corresponding interface cards). As an example, current supply circuitry may be included in a system that can boost a current supply of an interface card, for example, to supply current to multiple sensor units that are operatively coupled, at least in part, to a common multiphase power cable. As an example, current supplied via multiple interface cards may be combined into a common current supply to a multiphase power cable that is operatively coupled to multiple sensor units (e.g., via respective electric motor wye points).

As an example, an INSTRUCT™ acquisition and control unit (Schlumberger Limited, Houston, Tex.) may include one or more interface cards. As an example, an interface card may include circuitry that can receive multiplexed signals as transmitted at least in part via a multiphase power cable that powers multiple electric motors where the multiplexed signals include signals that originate at one sensor unit operatively coupled to a wye point of one of the electric motors and signals that originate at another sensor unit operatively coupled to a wye point of another one of the electric motors. In such an example, the interface card may include circuitry that can demultiplex multiplexed signals (e.g., multiplexed via a frequency based multiplexing technique and/or a time based multiplexing technique).

For FSD controllers, the UNICONN™ motor controller can monitor ESP system three-phase currents, three-phase surface voltage, supply voltage and frequency, ESP spinning frequency and leg ground, power factor and motor load. As an example, a controller such as, for example, a FSD controller may optionally control multiple ESPs. In such an example, control may optionally be based in part on signals received via one or more ESP coupled sensor units (e.g., consider demultiplexing of multiplexed signals from such sensor units).

For VSD units, the UNICONN™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground. As an example, a controller such as, for example, a VSD controller may optionally control multiple ESPs. In such an example, control may optionally be based in part on signals received via one or more ESP coupled sensor units (e.g., consider demultiplexing of multiplexed signals from such sensor units).

In the example of FIG. 2, the ESP motor controller 250 includes various modules to handle, for example, backspin of an ESP, sanding of an ESP, flux of an ESP and gas lock of an ESP. The motor controller 250 may include any of a variety of features, additionally, alternatively, etc.

In the example of FIG. 2, the VSD unit 270 may be a low voltage drive (LVD) unit, a medium voltage drive (MVD) unit or other type of unit (e.g., a high voltage drive, which may provide a voltage in excess of about 4.16 kV). As an example, the VSD unit 270 may receive power with a voltage of about 4.16 kV and control a motor as a load with a voltage from about 0 V to about 4.16 kV. The VSD unit 270 may include commercially available control circuitry such as the SPEEDSTAR™ MVD control circuitry marketed by Schlumberger Limited (Houston, Tex.).

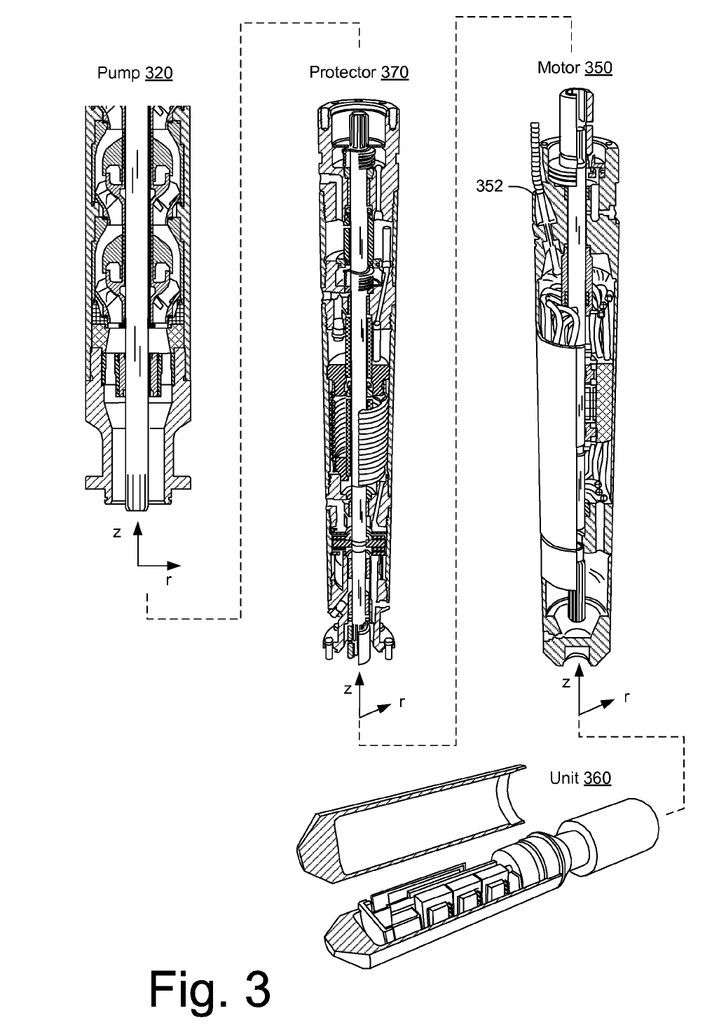

FIG. 3 shows cut-away views of examples of equipment such as, for example, a portion of a pump 320, a protector 370, a motor 350 of an ESP and a sensor unit 360. The pump 320, the protector 370, the motor 350 and the sensor unit 360 are shown with respect to cylindrical coordinate systems (e.g., r, z, Θ). Various features of equipment may be described, defined, etc. with respect to a cylindrical coordinate system. As an example, a lower end of the pump 320 may be coupled to an upper end of the protector 370, a lower end of the protector 370 may be coupled to an upper end of the motor 350 and a lower end of the motor 350 may be coupled to an upper end of the sensor unit 360 (e.g., via a bridge or other suitable coupling).

As shown in FIG. 3, a shaft segment of the pump 320 may be coupled via a connector to a shaft segment of the protector 370 and the shaft segment of the protector 370 may be coupled via a connector to a shaft segment of the motor 350. As an example, an ESP may be oriented in a desired direction, which may be vertical, horizontal or other angle. As shown in FIG. 3, the motor 350 is an electric motor that includes a connector 352, for example, to operatively couple the electric motor to a power cable, for example, optionally via one or more motor lead extensions (see, e.g., FIG. 4). Power supplied to the motor 350 via the connector 352 may be further supplied to the sensor unit 360, for example, via a wye point of the motor 350 (e.g., a wye point of a multiphase motor).

FIG. 4 shows a block diagram of an example of a system 400 that includes a power source 401 as well as data 402 (e.g., information). The power source 401 provides power to a VSD block 470 while the data 402 may be provided to a communication block 430. The data 402 may include instructions, for example, to instruct circuitry of the circuitry block 450, one or more sensors of the sensor block 460, etc. The data 402 may be or include data communicated, for example, from the circuitry block 450, the sensor block 460, etc. In the example of FIG. 4, a choke block 440 can provide for transmission of data signals via a power cable 411 (e.g., including motor lead extensions “MLEs”). A power cable may be provided in a format such as a round format or a flat format with multiple conductors. MLEs may be spliced onto a power cable to allow each of the conductors to physically connect to an appropriate corresponding connector of an electric motor (see, e.g., the connector 352 of FIG. 3). As an example, MLEs may be bundled within an outer casing (e.g., a layer of armor, etc.).

As shown, the power cable 411 connects to a motor block 415, which may be a motor (or motors) of an ESP and be controllable via the VSD block 470. In the example of FIG. 4, the conductors of the power cable 411 electrically connect at a wye point 425. The circuitry block 450 may derive power via the wye point 425 and may optionally transmit, receive or transmit and receive data via the wye point 425. As shown, the circuitry block 450 may be grounded. As an example, data may include commands, instructions, measurements, signals, etc. For example, the circuitry block 450 may receive an instruction via the wye point 425 where the instruction may instruct one or more sensors or, for example, other equipment.

As an example, power cables and MLEs that can resist damaging forces, whether mechanical, electrical or chemical, may help ensure proper operation of a motor, circuitry, sensors, etc.; noting that a faulty power cable (or MLE) can potentially damage a motor, circuitry, sensors, etc. Further, as an example, an ESP may be located several kilometers into a wellbore. Accordingly, time and cost to replace a faulty ESP, power cable, MLE, sensor, circuitry, etc., may be substantial (e.g., time to withdraw, downtime for fluid pumping, time to insert, etc.).

FIG. 5 shows an example of a system 510 and an example of a system 560. As shown, the system 510 includes a power cable 511, a junction box 512 that may be disposed at or proximate to a wellhead 514 where the junction box 512 can electrically splits the power cable 511 to a first power cable 516 and a second power cable 518. As an example, a junction box may be disposed at a different location. For example, consider a downhole junction box that may be disposed at or proximate to equipment 515 (e.g., a packer, header equipment mechanically coupled to an electric submersible pump or electric submersible pumps, etc.).

As shown, the first power cable 516 is operatively coupled to a first electric submersible pump (ESP) 520-1, which includes a pump 522-1, a protector 524-1, an electric motor 526-1 and a gauge 528-1 (e.g., a sensor unit). As shown, the second power cable 518 is operatively coupled to a second electric submersible pump (ESP) 520-2, which includes a pump 522-2, a protector 524-2, an electric motor 526-2 and a gauge 528-2 (e.g., a sensor unit). As an example, the ESPs 520-1 and 520-2 may be in fluid communication at their pump inlets and output from the ESPs 520-1 and 520-2 may optionally be directed to a common conduit that may extend to the well head 514.

In the system 510, the first power cable 516 extends from the first ESP 520-1 to the junction box 512 at a surface location (e.g., wellhead) and the second power cable 518 extends from the second ESP 520-2 to the junction box 512 where the junction box 512 joins the first and second power cables 516 and 518 such that the single power cable 511 may be operatively coupled to the junction box 512, which may provide for power to power the first and second ESPs 520-1 and 520-2. In such an example, the single power cable 511 may be a multiphase power cable configured to transmit at least power via the junction box 512 to the first ESP 520-1, the second ESP 520-2 or both the first and the second ESPs 520-1 and 520-2.

In the system 510, the power cable 511 via the junction box 512 can carry signals associated with the first gauge 528-1 of the first ESP 520-1 (e.g., a first sensor unit) and to carry signals associated with the second gauge 528-2 of the second ESP 520-2 (e.g., a second sensor unit). For example, such signals may be power signals, data signals, etc. For example, the first gauge 528-1 may be powered at a wye point of the first ESP 520-1 (e.g., of the electric motor 526-1) and the second gauge 528-2 may be powered at a wye point of the second ESP 520-2 (e.g., of the electric motor 526-2) and, for example, the first gauge 528-1 may transmit data via the wye point of the first ESP 520-1 and the second gauge 528-2 may transmit data via the wye point of the second ESP 520-2. As an example, two wye points may be operatively coupled to respective cables 516 and 518, which are joined, for example, at the junction box 512, which can be operatively coupled to the power cable 511 (e.g., a single multiphase cable).

As to the system 560 of FIG. 5, as shown, it includes a power cable 561 and a wellhead 564 as well as equipment 565 (e.g., a packer, header equipment mechanically coupled to an electric submersible pump or electric submersible pumps, etc.).

As shown, the power cable 561 is operatively coupled to a first electric submersible pump (ESP) 570-1, which includes a pump 572-1, a protector 574-1, an electric motor 576-1 and a gauge 578-1 (e.g., a sensor unit), and the power cable 561 is operatively coupled to a second electric submersible pump (ESP) 570-2, which includes a pump 572-2, a protector 574-2, an electric motor 576-2 and a gauge 578-2 (e.g., a sensor unit). As an example, the ESPs 570-1 and 570-2 may be in fluid communication at their pump inlets and output from the ESPs 70-1 and 570-2 may optionally be directed to a common conduit that may extend to the well head 574.

In the system 560, the power cable 561 is physically configured to extend to the first ESP 570-1 and to the second ESP 570-2. The power cable 561 may provide for power to power the first and second ESPs 570-1 and 570-2. In such an example, the single power cable 561 may be a multiphase power cable configured to transmit at least power to the first ESP 570-1, the second ESP 570-2 or both the first and the second ESPs 570-1 and 570-2

As shown, the power cable 561 of the system 560 may be configured to carry signals associated with the first gauge 578-1 of the first ESP 570-1 (e.g., a first sensor unit) and to carry signals associated with the second gauge 578-2 of the second ESP 570-2 (e.g., a second sensor unit). For example, such signals may be power signals, data signals, etc. For example, the first gauge 578-1 may be powered at a wye point of the first ESP 570-1 (e.g., of the electric motor 576-1) and the second gauge 578-2 may be powered at a wye point of the second ESP 570-2 (e.g., of the electric motor 576-2) and, for example, the first gauge 578-1 may transmit data via the wye point of the first ESP 570-1 and the second gauge 578-2 may transmit data via the wye point of the second ESP 570-2. As an example, two wye points may be operatively coupled to a single multiphase cable.

As an example, a system may support communication, between one end of a multi-phase electrical power cable where an electrical power source and telemetry receiver (and transmitter) is located uphole (at surface), and at the other end, where one or more electrical motors are installed downhole. As an example, such a system may include circuitry for time domain and/or frequency domain multiplexing, for example, to transmit and decode data (e.g., signals) from multiple sensors using a single cable to surface. As an example, a power cable may feed a junction box, which splits the conductors of the cable to deliver power to two ESPs and, for example, to transmit, receive, etc. signals from at least one of the ESPs. In such an example, the power cable that feeds the junction box may carry such signals where a choke or other circuitry may tap into the power cable for communication of signals, optionally using one or more techniques (e.g., time domain, frequency domain, etc.) that associate signals with particular equipment (e.g., a first ESP, a second ESP; noting that each ESP may include multiple pieces of equipment configured for communication of signals).

As an example, a method may include remote monitoring of various parameters for purposes of improved operation of downhole equipment. For example, to control operational conditions and to know actual values of well parameters related to a surrounding reservoir or well bore fluids. In such an example, the method may include communicating signals via a link (e.g., data signals, etc.) between downhole equipment and uphole equipment (e.g., surface equipment). As shown in the example systems 510 and 560 of FIG. 5, a single power cable may be provided for delivery of electrical power to one or more motors and to provide for transmission of signals (e.g., uphole, downhole or uphole and downhole) to equipment coupled to the one or more motors (e.g., gauges, sensors, circuitry, etc.). As an example, a system may include a junction box or junction boxes such as, for example, the junction box 512 of the system 510 of FIG. 5.

As an example, a system may include a choke configured to receive signals that may be associated with more than one piece of downhole equipment. For example, a choke such as the choke 440 of FIG. 4 may tap one or more phases of a multiphase power cable and pass transmitted signals to communication circuitry such as the communication circuitry 430, which may optionally be configured to distinguish signals associated with one piece of equipment from signals associated with another piece of equipment. For example, the pieces of equipment may be a first gauge operatively coupled to a wye point of a first electric motor and a second gauge operatively coupled to a wye point of a second electric motor. In such an example, one or more chokes may be provided that tap a single multiphase cable to distinguish signals of the first gauge from signals of the second gauge (e.g., measurements from a sensor of the first gauge from measurements from a sensor of the second gauge).

As an example, a system may include a multiphase power cable configured to be operatively coupled to two or more gauges (e.g., from downhole to surface). In such an example, signals from each of the two or more gauges may be communicated using different frequency channels and/or using different times (e.g., time-based transmissions). As an example, a system may include multiplexing (e.g., frequency-based, time-based, etc.).

As an example, a method can include transmitting information from two or more gauges connected to the same cable to surface. As an example, circuitry operatively coupled to a sensor may transmit sensed information by modulating current supplied or, for example, by transmitting a signal to the surface. As an example, a method can include multiplexing signals from two or more sensors by using two or more frequency channels and/or by transmitting from each sensor at a separate time (e.g., to avoid overlap in time for a signal or portions of a signal).

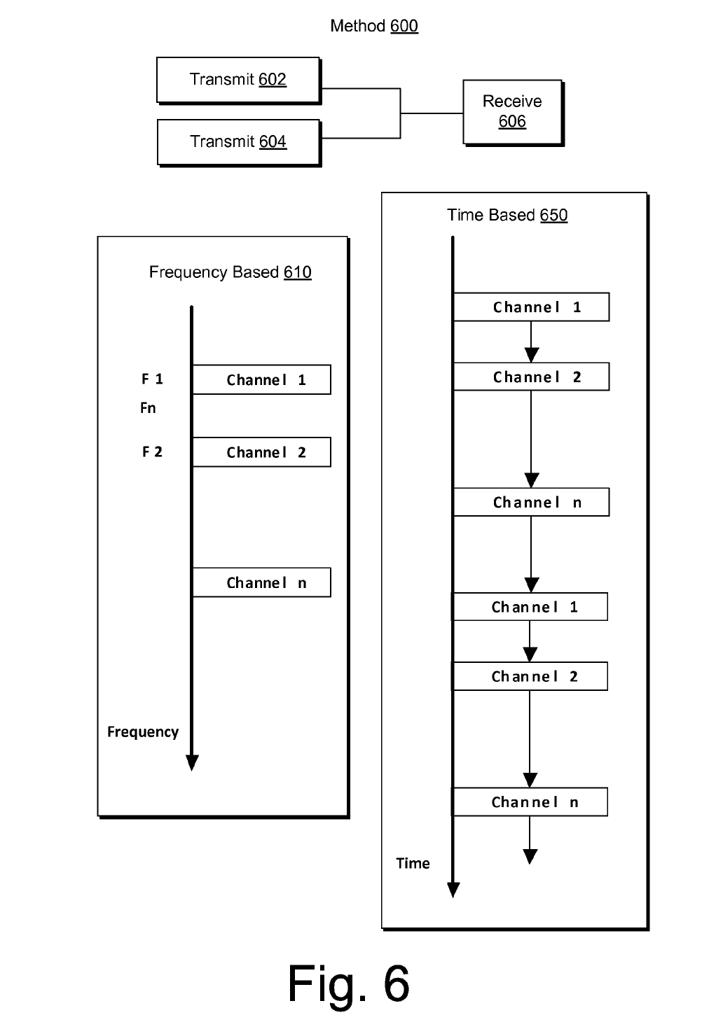

FIG. 6 shows an example of a method 600, an example of a frequency based multiplexing technique 610 and an example of a time based multiplexing technique 650. As shown, the method 600 includes a transmission block 602 for transmitting a signal from a sensor unit of a first electric submersible pump via a wye point of an electric motor to a multiphase power cable; a transmission block 604 for transmitting a signal from a sensor unit of a second electric submersible pump via a wye point of an electric motor to the multiphase power cable; and a reception block 606 for receiving the transmitted signals via a choke operatively coupled to the multiphase power cable. As an example, the method 600 may act to reduce risk of conflict as to transmission of signals from one sensor unit and signals from another sensor unit.

As an example, the method 600 may be considered to be a power cable based multi-sensor unit signal transmission method. For example, where multiple sensor units can be disposed in a downhole environment (e.g., in a bore or in one or more bores that may extend from a common bore) and operatively coupled to a single multiphase power cable via wye points of respective electric motors that are powered by the single multiphase power cable. Such a power cable may include branches where a branch extends to one electric motor and where another branch extends to another electric motor. As an example, a junction may exist at a branch. As an example, a junction connector may be a splitter that splits multiple phases (e.g., multiple conductors) of a common power cable into branches. As an example, a junction may include circuitry (e.g., junction box circuitry). As an example, a branch may extend into a side bore, for example, a bore that extends from a main bore. As an example, branches may be in a common bore (e.g., a common wellbore).

In the example of FIG. 6, the method 600 may include multiplexing, for example, where the transmitted signals are multiplexed for transmission via the multiphase power cable. As an example, frequency based multiplexing may be implemented (see, e.g., the technique 610) and/or time based multiplexing may be implemented (see, e.g., the technique 650).

As an example, the technique 610 may include channel 1 being assigned frequency F1, channel 2 being assigned frequency F2, and channel n being assigned frequency Fn (e.g., where n is zero or an integer greater than 2).

As an example, one or more techniques may implement principles of orthogonality. For example, consider a CDMA approach where several transmitters can send information simultaneously over a single communication channel. Such an approach can allow two or more pieces of downhole equipment (e.g., coupled via a single multiphase power cable to surface equipment, etc.) to share a frequency of band of frequencies. Such an approach may employ spread-spectrum technology and a coding scheme (e.g., where each transmitter is assigned a code). As an example, a technique may be synchronous, asynchronous, etc.

As to the technique 650 of FIG. 6, consider, for example, an order that exists for channels, optionally where each channel may have an associated time window. As an example, where information is not included in a signal (e.g., data, etc.), a default signal (e.g., a default code, etc.) may exist in a window or a window may be blank (e.g., noise, etc.). As an example, a system may employ time-division multiplexing (TDM) as a method of transmitting and receiving independent signals over a common signal path, for example, using synchronized switches, etc. For example, at each end of a transmission line, each signal may appear on the line for a period of time (e.g., optionally in an alternating pattern). As an example, a statistical time division multiplexing (STDM) technique may be employed, for example, where address of a terminal and data itself may be transmitted together (e.g., to split bandwidth over a communication path).

As an example, a method can include transmitting multiple analog message signals or digital data streams associated with downhole equipment over a shared multiphase power cable, which may be coupled to surface equipment. In such an example, a wye point of an electric motor may be disposed between a piece of downhole equipment and surface equipment (e.g., such that communication uphole and/or downhole passes via the wye point).

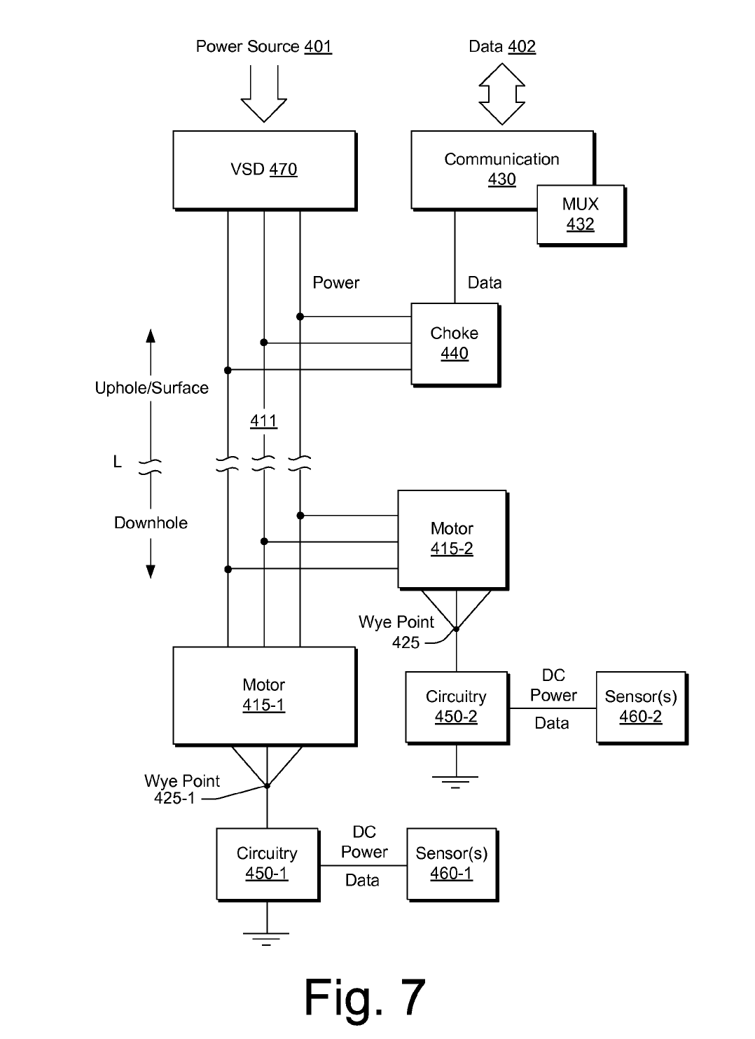

FIG. 7 shows an example of the system 400 as including another motor 415-2, another wye point 425-2, another circuitry 450-2 and another sensor(s) 460-2, which are collectively operatively coupled to the multiphase power cable 411. In the example of FIG. 7, the system 400 may include multiplexing circuitry 432 (e.g., for coding, decoding, coding and decoding, etc.) for communicating (e.g., receiving, transmitting, receiving and transmitting, etc.) information. In the example of FIG. 7, the choke 440 is operatively coupled to the single multiphase power cable 411, for example, to tap into signals communicated via the wye point 425-1 and signals communicated via the wye point 425-2.

As an example, a system such as the system 400 of FIG. 7 may include a junction box, for example, disposed at a surface location. For example, the power cable 411 may couple to each of the motors 415-1 and 415-2 via a junction box, which may be located uphole at a surface location. In such an example, a single multiphase power cable may extend from the junction box to a power supply where, for example, a choke may be positioned to tap into the multiphase power cable for purposes of receiving and/or transmitting signals to one or more of the ESP systems (e.g., to the circuitry 450-1 or to the circuitry 450-2 or to both the circuitry 450-1 and the circuitry 450-2).

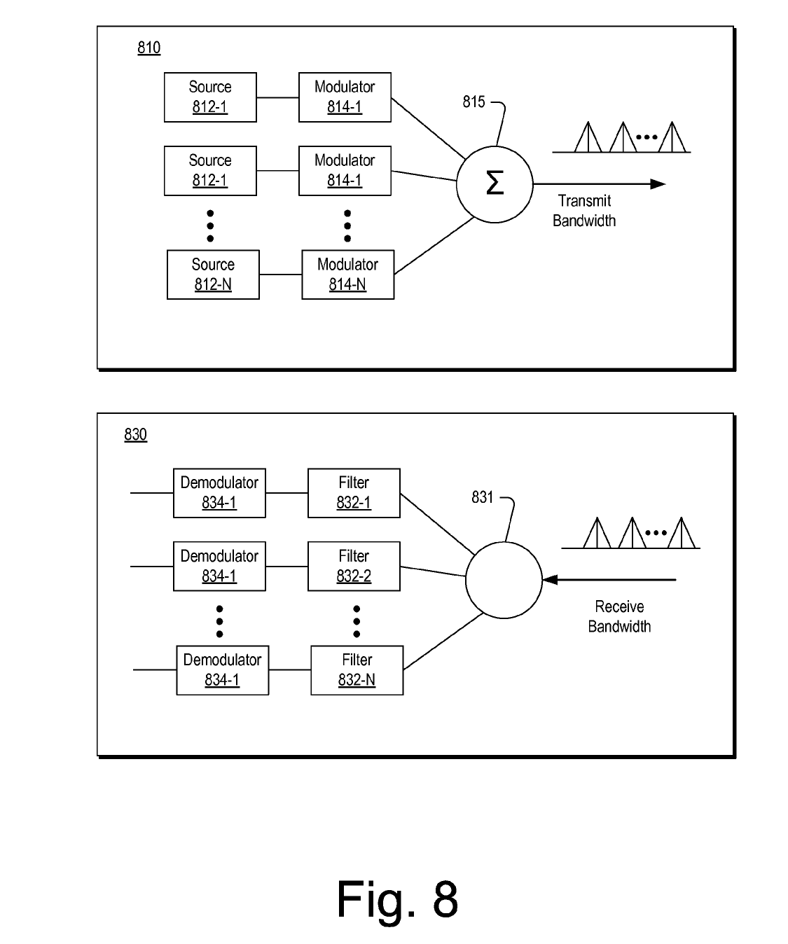

FIG. 8 shows an example of a frequency based arrangement of circuitry for transmission 810 and an example of a frequency based arrangement of circuitry for reception 830. As shown, the circuitry for transmission 810 includes sources 812-1, 812-2 to 812-N and modulators 814-1, 814-2 to 814-N, where N may be 0 or an integer value greater than 0. As shown, the circuitry for transmission 810 also includes a summing circuit 815, which may sum signals, for example, for transmission along a common transmission medium or media (e.g., a wire or wires). As to the circuitry for reception 830, it includes a reception circuit 831, filters 832-1, 832-2 to 832-N and demodulators 834-1, 834-2 to 834-N, where N may be 0 or an integer value greater than 0.

In frequency division multiplexing, available bandwidth of a physical medium (e.g., or collective media) may be subdivided into several independent frequency channels. In such an example, independent message signals may be translated into different frequency bands, for example, using one or more modulation techniques. As an example, signals may be combined by a linear summing circuit, for example, as multiplexer, which may form a composite signal. As an example, a composite signal may be transmitted along a “channel” (e.g., a wire or set of wires), for example, electromagnetically. As an example, an approach to frequency based transmissions may divide available bandwidth into a number of smaller, independent frequency channels. Using modulation, independent message signals may be translated into different frequency bands. As an example, modulated signals may be combined in a linear summing circuit to form a composite signal for transmission. As an example, a “carrier” used to modulate an individual message signal may be referred to as a sub-carrier. For example, a system may include a number of sub-carriers.

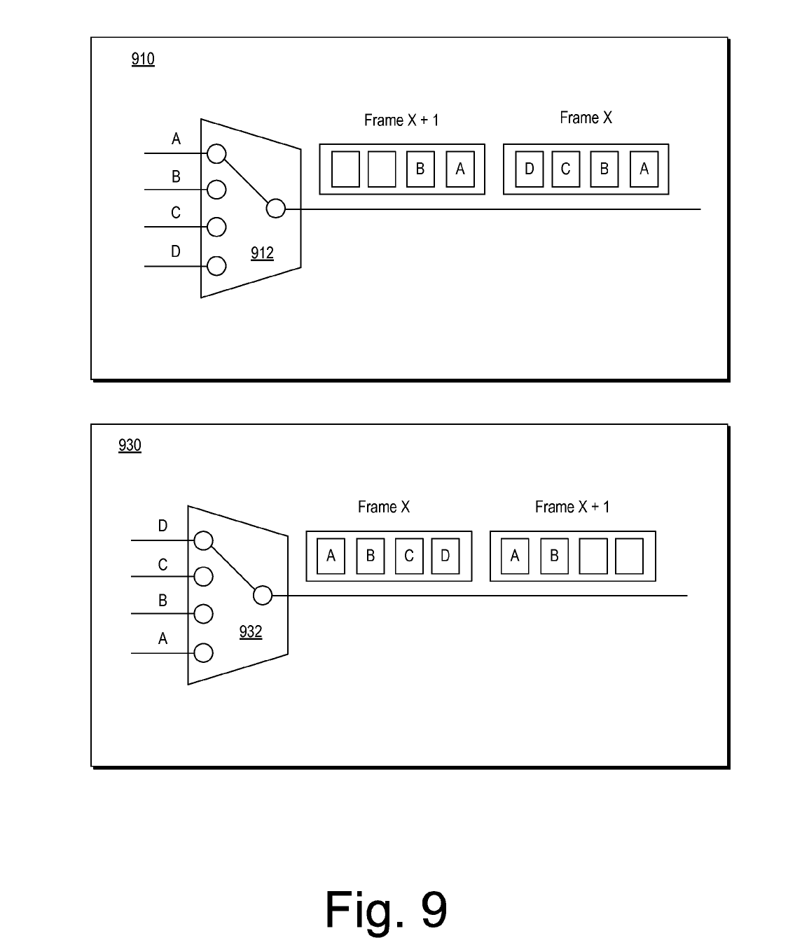

FIG. 9 shows an example of a time based arrangement of circuitry for transmission 910 and an example of a time based arrangement of circuitry for reception 930. As shown, the circuitry for transmission 910 includes source signals A, B, C and D (e.g., two or more source signals) that are received by a multiplexing unit 912. As an example, the multiplexing unit 912 may be controlled to “package” information as frames. For example, consider a Frame X with information packaged for signal sources A, B, C and D and another Frame X+1 with information packaged for signal sources A and B. As shown, the circuitry for reception 930 includes a ve the frames Frame X and Frame X+1 as packaged by the circuitry 910 and break the frames into individual signals (e.g., signals A, B, C or D).

As an example, in frequency division multiplexing, signals may be contemporaneous while in time-division multiplexing, signals are at different times, optionally at a common frequency or frequency band. As an example, an electronic commutator may be implemented that sequentially samples signal sources and combines signals, if present, to form a composite base band signal, which may be transmitted via a medium or media (e.g., a wire or wires). A demultiplexed may be provided at a receiving end, for example, to de-multiplex independent message signals (e.g., by a corresponding electronic commutator). As an example, incoming data from individual sources may be briefly buffered where, for example, a buffer may be of about a bit or a character in length. As an example, buffers may be scanned sequentially to form a composite data stream. As an example, a scan operation may be sufficiently rapid so that each buffer is emptied before more data can arrive. As an example, a criterion may be set such that a composite data rate is at least equal to a sum of individual data rates.

As an example, dead space may exist between successive sampled signals, for example, to diminish risk of crosstalk. As an example, a synchronizing signal (e.g., pulse) may be transmitted, for example, on a per cycle basis. As an example, a frame may include time slots where an individual slot is dedicated to a particular source and/or type of information. As an example, a maximum bandwidth (e.g., data rate) of a TDM system may be at least equal to the same data rate of sources.

As an example, synchronous TDM may be implemented where each time slot is pre-assigned to a fixed source (e.g., or data type from a source). In such an example, time slots can be transmitted irrespective of whether the sources have data to send or not.

As an example, a system may implement a time based approach where, for example, sources may include or be of different data rates. For example, consider assigning fewer slots per cycle to a slower input than a faster input.

As an example, an approach may implement statistical TDM, also known as asynchronous TDM or Intelligent TDM. Such an approach may dynamically allocate one or more time slots on demand to separate inputs. As an example, during input, a multiplexer may scan input buffers, collecting data until a frame is filled and then send the frame. At a receiving end, a demultiplexer may receive the frame and distributes the data to the appropriate buffers. As an example, an asynchronous approach may lead to smaller time for transmission and better utilization of bandwidth of a medium or media. As an example, in asynchronous transmission, data in a slot can include an address part, for example, to identifies the source of data.

As an example, a system may implement an orthogonal FDM (OFDM) spread spectrum technique that may distribute data over a large number of carriers that are spaced apart at precise frequencies. Such spacing can provide orthogonality, which can help prevent demodulators from seeing frequencies other than their own.

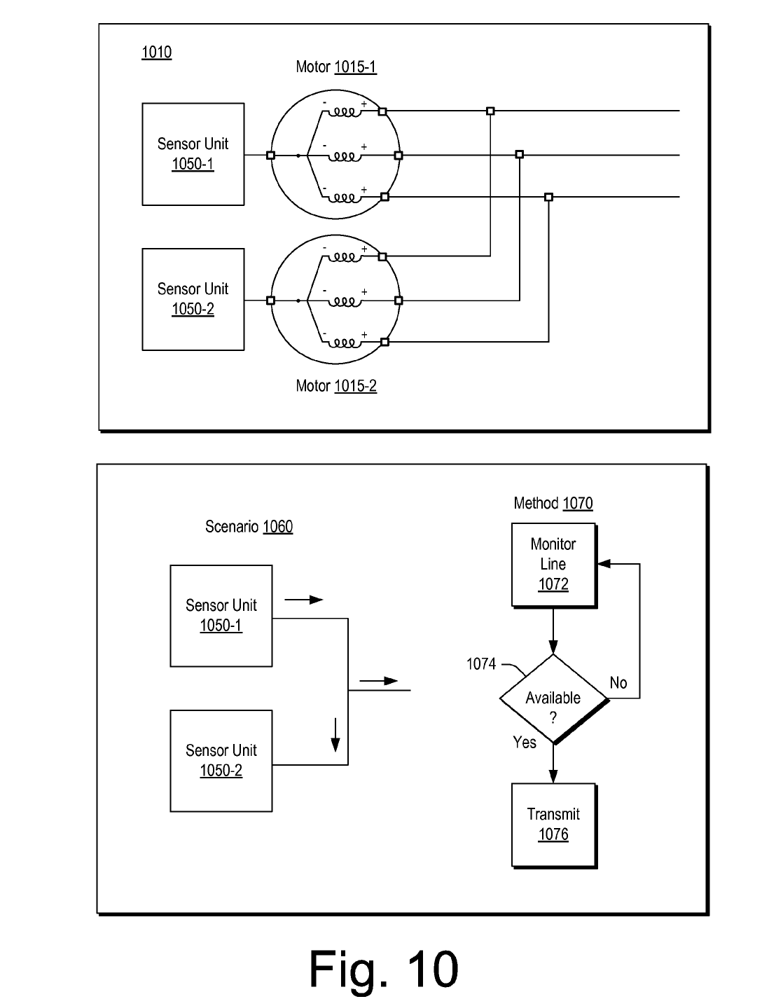

FIG. 10 shows an example arrangement 1010, an example scenario 1060 and an example method 1070. The arrangement 1010 includes motors 1015-1 and 1015-2 and sensor units 1050-1 and 1050-2. As shown, a common multiphase cable is operatively coupled to the motors 1015-1 and 1015-2 and the sensor units 1050-1 and 1050-2 are operatively coupled to respective wye points of the motors 1015-1 and 1015-2. In the arrangement 1010, as illustrated by the scenario 1060, where one sensor unit transmits a signal, the other sensor unit may receive at least part of a transmitted signal. In such an example, as illustrated by the method 1070, in a monitor block 1072, a sensor unit may monitor a line and then decide per a decision block 1074 whether the line is available for transmission. As shown, where the decision block 1074 decides that the line is available, the sensor unit may utilize the line for transmission. The arrangement 1010 may be considered as being particular to the electrical connections where the two motors 1015-1 and 1015-2 are powered by a common cable and where the sensor units 1050-1 and 1050-2 are electrically connected to that common cable.

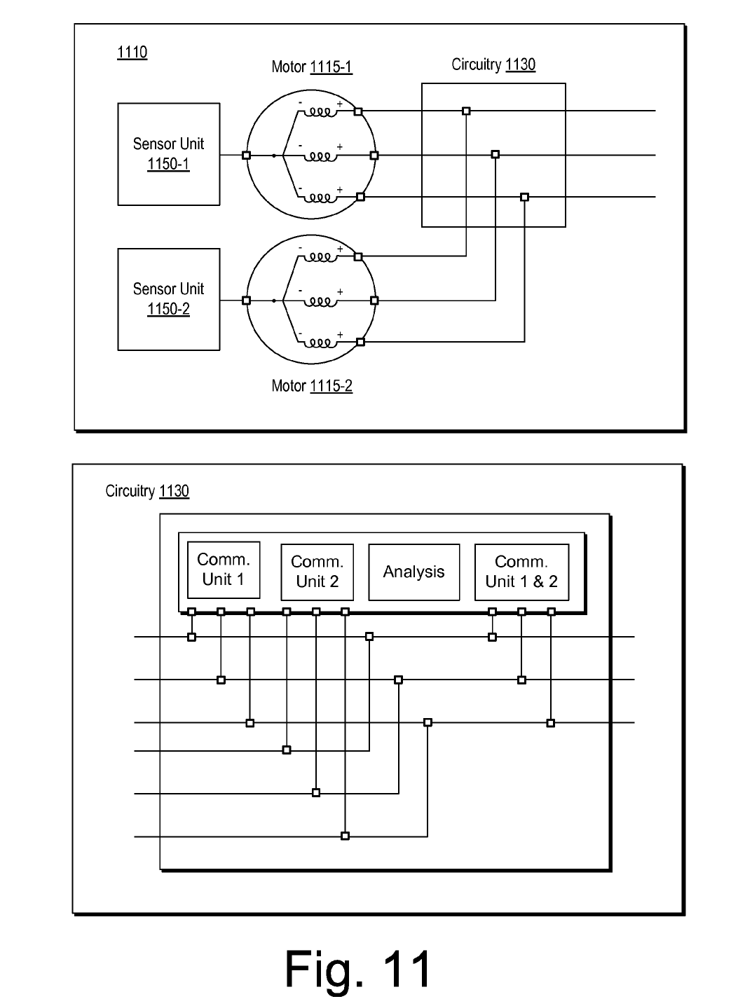

FIG. 11 shows an example arrangement 1110 that includes motors 1115-1 and 1115-2, sensor units 1150-1 and 1150-2 and circuitry 1130. As shown, the circuitry 1130 can include taps that tap into the power cable conductors. For example, the circuitry 1130 can include a first communication unit (Comm. Unit 1) and a second communication unit (Comm. Unit 2) that tap into a cable portion associated with the motor 1115-1 and the motor 1115-2, respectively. In such an example, the circuitry 1130 may analyze communication signals and control transmission of signals, etc., for example, via a tap that is uphole of a power split juncture. As an example, the circuitry 1130 may include choke circuitry and other circuitry. As an example, the circuitry 1130 may “strip” out signals of one or more sensor units and then repackage signals for transmission. As an example, the circuitry 1130 may be part of a junction box, which may be, for example, a downhole junction box that provides for splitting power of a cable to power multiple motors (e.g., multiple ESP motors of separate ESP systems). As an example, the junction box 512 of the system 510 of FIG. 5 may include circuitry such as the circuitry 1130 of FIG. 11.

As an example, a sensor unit (e.g., a gauge) may include multiple sensors. As an example, one or more of sensors may sense information associated with operation of equipment driven by an electric motor. As an example, one or more sensors may sense information associated with operation of an electric motor. Table 1, below, shows some examples of types of measurements with examples of ranges and examples of rates.

TABLE 1
Example Measurements

| Measurement | Range | Rate |
|---|---|---|
| Intake Pressure, kPa | 0 to 39,000 | 4 s |
| Discharge Pressure, kPA | 0 to 39,000 | 4 s |
| Intake Temp., C. | 0 to 150 | 4 s |
| Motor/Oil Temp., C. | 0 to 409 | 36 s |
| Vibration, g | 0 to 30 | Variable |
| Current Leakage, mA | 0 to 25 | Variable |

As an example, where two sensor units may include sensors that can provide measurements as in Table 1. As an example, a time-based approach may package information into frames where a frame may be a single sensor unit frame or a multi-sensor unit frame. For example, a frame may include multiple measurements from a single sensor unit or a frame may include multiple measurements where the measurements include at least one measurement from one sensor unit and at least one measurement from another sensor unit. As an example, a frame may include information additional to one or more measurements. For example, a frame may include identifier information (e.g., a sensor unit ID, a sensor ID, a measurement ID, etc.).

As an example, as to a frequency based approach, a sensor unit may be assigned a frequency that differs from that of another sensor unit. As an example, a sensor unit may be assigned a plurality of frequencies, for example, where each frequency may correspond to a different type of measurement (see, e.g., the measurements of Table 1) while another sensor unit may be assigned a plurality of frequencies that differ individually from those of the other sensor unit. As an example, a first sensor unit may transmit temperature measurements using a temperature measurement frequency and a second sensor unit may transmit temperature measurements using a different temperature measurement frequency where the temperature measurements of the first and the second sensor units may be transmitted contemporaneously (e.g., at least in part over a common span of time). As an example, a frequency based approach may implement so-called guard frequencies, which may be bands that act to separate frequencies that may be used to transmit information (e.g., measurements).

As an example, a downhole sensor unit may be operatively coupled to electric submersible pump and may measure one or more of downhole pressures, temperatures, current leakage, and vibration. Such measurements may be analyzed for one or more purposes, for example, consider ESP integrity, lift performance, etc. As an example, a sensor unit may include digital telemetry circuitry. As an example, a sensor unit may include circuitry that can tolerate phase imbalance and, for example, an ability to handle voltage spikes.

As an example, a sensor unit may include one or more configuration options. For example, the PHOENIX™ xt150 gauge may include a Type 0 and a Type 1 configuration option. As an example, a sensor unit (e.g., a gauge) may include a multi-ESP sensor configuration option. For example, where a sensor unit is one of a plurality of sensors units that are operatively coupled to a common cable, a configuration option may be provided that can account for presence of one or more other sensors units.

As an example, an option may provide for measuring intake pressure and temperature, motor oil or motor winding temperature, vibration, and current leakage and, for example, another option may provide for further measuring pump discharge pressure (e.g., as a performance metric). As an example, a pressure across a pump may be calculated and, for example, points on a pump curve plotted. As an example, pressure across a pump may help to diagnose pump operation, etc.

As an example, one or more alarms may be set that can be triggered via an analysis of one or more measurements. For example, if a temperature exceeds a temperature limit, an alarm may be triggered. As an example, one or more alarms may be associated with monitoring of an ESP.

As an example, a sensor may include circuitry suitable for SCADA. As an example, a sensor may include circuitry that can implement a MODBUS™ protocol. For example, a sensor may operate as a MODBUS™ protocol terminal. As an example, a sensor may include one or more busses, ports, etc. As an example, a sensor may include RS232 and/or RS485 capabilities (e.g., for communication of information).

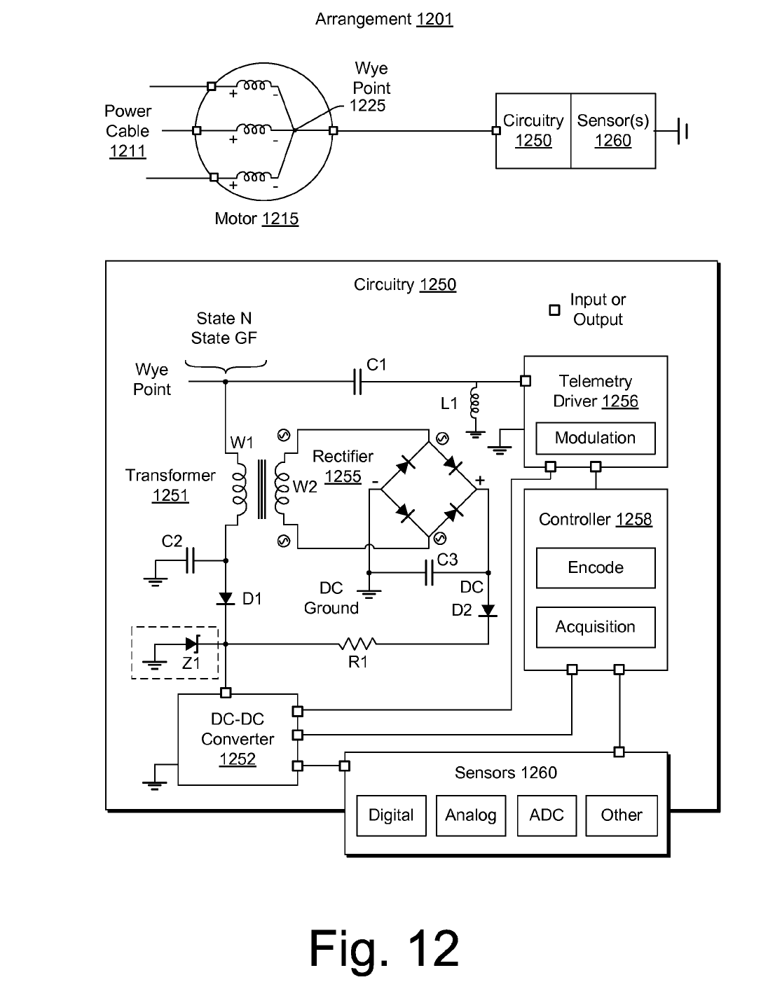

FIG. 12 shows an example arrangement 1201 as to a power cable 1211, a motor 1215, a wye point 1225, circuitry 1250 and one or more sensors 1260. As to the circuitry 1250, it may be operatively coupled to the one or more sensors 1260. In the example of FIG. 12, the circuitry 1250 includes an electrical connection to a wye point of a motor, a transformer 1251, a DC-DC converter 1252, a rectifier 1255, a telemetry driver 1256 and a controller 1258. In the example of FIG. 12, the circuitry 1250 may include various components such as diodes (D), Zener diodes (Z), capacitors (C), inductors (L), windings (W), resistors (R), etc. As to the Zener diodes, as an example, the Zener diode Z1 may be optional.

As indicated, the circuitry 1250 may operate in State N (normal) or a State GF (ground fault), for example, with respect to the wye point. In the example of FIG. 12, for State N, a primary winding (W1) of the transformer 1251 acts to reduce detrimental impact of normal wye point unbalance and allows a DC power signal to proceed to the DC-DC converter 1252. The DC-DC converter 1252 can convert the DC power signal and provide one or more converted DC power signals to the telemetry driver 1256, the controller 1258 and the one or more sensors 1260.

In the example of FIG. 12, for State GF, where abnormal, unintentional unbalance exists at the wye point (e.g., due to a ground fault), the primary winding (W1) of the transformer 1251 acts to reduce detrimental impact of the abnormal wye point unbalance and further cooperates with the secondary winding (W2) to allow the rectifier 1255 to derive a suitable DC power signal. As shown, a positive DC tap point of the rectifier 1255 is electrically connected to the DC-DC converter 1252. In such a manner, when a ground fault exists, unbalance voltage of alternating current at the wye point can be stepped down via the transformer 1251 and then rectified via the rectifier 1255 to supply a suitable DC power signal to the DC-DC converter 1252, which may supply one or more DC power signals to the telemetry driver 1256, the controller 1258 and the one or more sensors 1260. As an alternative, the rectifier 1255 (e.g., optionally with associated circuitry) may provide a DC power signal or signals suitable for powering the telemetry driver 1256, the controller 1258 or the one or more sensors 1260 (e.g., without reliance on the DC-DC converter 1252).

As to telemetry, the telemetry driver 1256 includes an electrical connection to the wye point 1225. Sensed information (e.g., data) from the one or more sensors 1260 may be acquired by the controller 1258 and encoded using encoding circuitry. The encoded information may be provided to the telemetry driver 1256 where modulation circuitry provides for signal modulation to carry the encoded information for transmission via the wye point of an electric motor. As an example, the telemetry driver 1256 may alternatively or additionally receive information from the wye point. Where such information is modulated, encoded, or modulated and encoded, the circuitry 1250 may provide for demodulation, decoding or demodulation and decoding.

As to the telemetry driver 1256, as an example, it may transmit information to a wye point of an electric motor at one or more frequencies (e.g., approximately 10 kHz or more) higher than a power supply frequency of power supplied to drive the electric motor, which may be less than approximately 100 Hz and, for example, in a range of about 30 Hz to about 90 Hz. As an example, an electric motor may be supplied with power having a frequency of about 60 Hz. As an example, transmitted data signals may be modulated using multichannel frequency shift keying (FSK), orthogonal frequency division multiplexing (OFDM), or phase shift keying (PSK). As an example, telemetry may occur at one or more frequencies, which may include one or more frequencies greater than about 5 kHz, one or more frequencies greater than about 10 kHz, one or more frequencies greater than about 20 kHz, and/or one or more frequencies greater than about 30 kHz. As to some examples, telemetry may occur using two frequencies, three frequencies, four frequencies, five frequencies or more than five frequencies.

As an example, as shown in FIG. 12, an LC circuit may be formed by the capacitor Cl and the inductor L1, for example, as disposed between the wye point and the telemetry driver 1256. Such an LC circuit may be tuned, for example, for downhole signal transmissions, uphole signal transmission, etc. As an example, one or more components in the circuitry 1250 may act to divide voltage, for example, with respect to paths electrically coupled to the wye point. For example, in a ground fault scenario, a high voltage (e.g., elevated voltage) may exist at the wye point. As an example, an LC circuit may be part of a voltage divider to help ensure that a voltage does not exceed a voltage level that may risk damaging circuitry (e.g., the telemetry driver 1256). As an example, the capacitor Cl may be tuned with respect to a voltage level as to dividing voltage at the wye point, for example, where the voltage at the wye point may become elevated due to a ground fault as to one or more of the phases of the multiphase power conduction system. As an example, circuitry may include voltage divider components that divide voltage with respect to a wye point where a telemetry driver is electrically coupled to the wye point along one branch and where circuitry such as a transformer, a DC-DC converter, etc. is electrically coupled to the wye point along another branch.

As an example, a system can include data communication circuitry where the system includes at least two electric motors powered by electrical energy supplied via power conductors (e.g., of a power cable) that carry at least AC power (e.g., and optionally DC power, AC signals, DC signal, etc.). In such an example, the electric motors may each include an inductor network coupled to the power conductors and a node such as a wye point. As an example, data communication circuitry can include, for example, for each of the at least two electric motors, a respective data transmission subsystem that can generating a modulated signal that can be supplied to the node of a respective electric motor. As an example, data communication circuitry can include, for each of the at least two electric motors, a respective interface circuit operably coupled between a corresponding data transmission subsystem and a corresponding node (e.g., for high pass filtering of a modulated signal).

As an example, interface circuits can provide AC-coupling such that DC signal variations that exist on a respective conductor coupled thereto may be blocked and isolated from passing therethrough. As an example, interface circuits may provide high pass filtering that filters out unwanted low frequency signal components (e.g., including the low frequency three-phase ESP power signal) that can exist on respective conductors of a power cable. As an example, a surface unit may include a secondary power supply circuitry that can generate a secondary AC power supply signal and drive circuits (e.g., amplifiers, etc.) that can communicate the secondary AC power supply signal over conductors of a power cable.

As an example, a sensor unit can include an interface circuit that is electrically-coupled to a wye point of a motor. Such an interface circuit can provide AC-coupling such that DC signal variations that occur at a wye point may be blocked and isolated from passing therethrough. As an example, an interface circuit can provides high pass filtering that may, for example, filter out unwanted low frequency signal components (e.g., including those low frequency components that may be derived from a three-phase ESP power signal), which may exist at a wye point. As an example, high-pass filtering functionality of an interface circuit may pass secondary AC power supply signal generated by secondary power supply circuitry (e.g., of a surface unit).

As an example, a sensor unit can include DC power conversion circuitry that is electrically coupled to a wye point of an electric motor. As an example, DC power conversion circuitry may convert secondary AC power signals, which may exist at a wye point, into one or more DC power signals (e.g., suitable for powering one or more other components).

As an example, communication circuitry of a sensor unit can include a modulator circuit, which may be operatively coupled to a processor, for example, where the modulator circuit can generate a modulated AC signal. As an example, such a signal may include information such as digital data. Such digital data may be considered to be telemetry data, for example, that represents measurements acquired by one or more sensors of a sensor unit. As an example, digital data may be processed and transmitted according to a frequency based approach and/or time based approach for purposes of multiplexing with respect to digital data from one or more other sensor units that are to be carried by a common multiphase power cable. As an example, digital data may be packetized (e.g., an error detection checksum, etc.).

As an example, a sensor unit can include a modulator circuit that can vary an amount of current drawn from a wye point of an electric motor, for example, in generating a modulated AC signal that may be communicated via conductors of a power cable. As an example, such current variations may be generated at a frequency relative to a frequency of a secondary power supply signal and, for example, according to a frequency based approach to multiplexing. As an example, frequency of current variations may be based at least in part on a frequency of a second power supply signal. As an example, current variations may occur at times that are synchronous with zero-crossings in a voltage level of a secondary power supply signal. Such an approach may act to reduce inrush currents (e.g., to help decrease stress on components). As an example, a relationship of frequency of a secondary power signal to a frequency of a modulated AC signal may be selected to provide for purposes of multiplexing; noting that synchronization of a secondary power signal frequency to a frequency of a modulated AC signal may improve effective signal-to-noise ratio (e.g., as received by receiver circuitry).

As an example, a sensor unit can include a zero-crossing detector, which may generate timing signals that are synchronous to such zero-crossings and supply these timing signals to other circuity, for example, to control modulation by a modulator circuitry (e.g., for purposes of data transmission, multiplexing, etc.). As an example, a frequency of a modulated AC signal may be an integer multiple of a secondary power signal frequency. As an example, a time based approach to multiplexing may be based at least in part on information from one or more zero-crossing detectors (e.g., zero-crossing times, etc.), for example, to coordinate timings sensor unit transmissions via a power cable that supplies power to multiple electric motors.

As an example, signals generated by each of the data transmission subsystems may adhere to a data transmission scheme, which may be, for example, a frequency based scheme and/or a time based scheme. Such schemes may be considered, for example, multiplexing schemes that can allow for multiple signals originating from multiple data transmission subsystems to be carried by conductors of a single power cable (e.g., a multiphase power cable) that powers multiple electrical motors. As an example, the power conductors of such a power cable may be operatively coupled to an assembly positioned at a remote location, which may be, for example, a location at or proximate to a wellhead, at a drive unit, etc. As an example, an interface card may include circuitry that can, for example, demultiplex multiplexed data transmissions carried by conductors of a power cable.

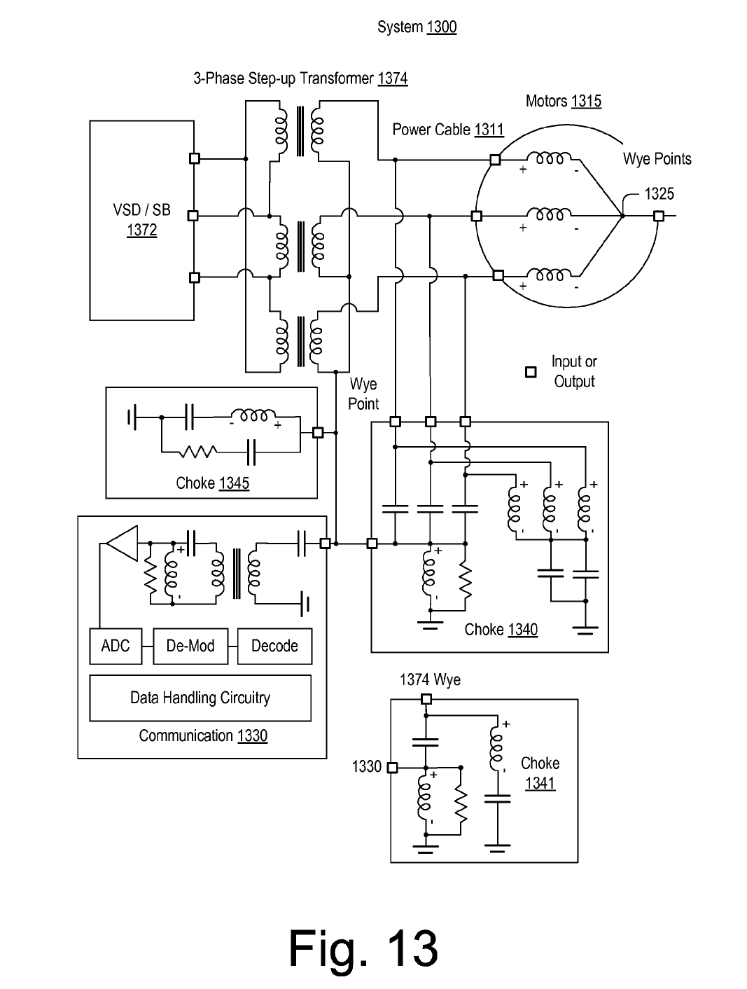

As to circuitry that may be uphole from a motor, FIG. 13 shows an example of a system 1300, which includes a power cable 1311, motors 1315, a respective wye point of the wye points 1325, communication circuitry 1330, a choke 1340, a choke 1345, a VSD unit and/or switchboard (SB) 1372, and a 3-phase step-up transformer 1374. FIG. 13 also shows an alternative arrangement 1341, for example, with a single phase choke that can connect to a wye point of the transformer 1374.

In the example of FIG. 13, the motors 1315 may be operatively coupled to the power cable 1311. In such an example, each of the motors 1315 may include an associated sensor unit that is operatively coupled to a respective one of the wye points 1325. In such an example, data transmitted via wye points 1325 of the motors 1315 may be carried by the power cable 1311.

To provide for redundancy, as an example, the choke 1340 includes electrical connections to each of the conductors for the 3-phase power. Such redundancy can allow the choke 1340 to receive modulated data signals provided to the wye points 1325, for example, regardless of the state of each of the individual conductors that electrically connect to the wye points 1325 (e.g., assuming at least one non-faulted conductor). In the example of FIG. 13, the wye points 1325 may receive modulated data signals via circuitry such as, for example, the circuitry 1250 of FIG. 12, etc.

As shown, the choke 1340 includes an electrical connection to the communication circuitry 1330. The communication circuitry 1330 may receive modulated signals from the choke 1340 and provide for conversion of such signals from analog to digital, provide for demodulation of such signals, provide for decoding of such signals or any combination thereof. The communication circuitry 1330 may include data handling circuitry, for example, to further process data derived from signals transmitted via the choke 1340. Such further processing may include formatting, analyzing, etc. As to formatting, the data handling circuitry may provide for formatting data according to one or more data transmission protocols (e.g., Internet, proprietary, etc.).

The communication circuitry 1330 may optionally be linked to equipment shown in the examples of FIGS. 1, 2 and 3. For example, the communication circuitry 1330 may be linked to the network 125 of FIG. 1 or linked to the network 201 of FIG. 2 or to the sensor unit 360 of FIG. 3. As an example, an implementation of the system 1300 of FIG. 13 may be in a geologic environment such as the geologic environment 120 and/or the geologic environment 140 of FIG. 1.

As an example, the communication circuitry 1330 may include circuitry for digital signal processing (DSP). As an example, the communication circuitry 1330 may provide for handling signals modulated using frequency based and/or time based techniques. As an example, the communication circuitry 1330 may include circuitry for multichannel frequency shift keying (FSK), orthogonal frequency division multiplexing (OFDM), and/or phase shift keying (PSK). For example, the communication circuitry 1330 may include circuitry for demodulating signals modulating using one or more of FSK, OFDM, PSK, etc.

As an example, the communication circuitry 1330 or other circuitry may provide for sampling each phase line of a 3-phase power cable individually for purposes of extracting data. For example, the choke 1340 may include a multiplexer controllable by the communication circuitry 1330 to allow the communication circuitry 1330 to select individual lines or optionally combinations of any two lines. In such a manner, if a ground fault does occur, the communication circuitry 1330 may provide for selecting the best individual line or combination of lines in an effort to improve performance (e.g., demodulation, decoding, etc.).

As an example, downhole equipment may provide for transmission of a test signal, which may optionally be modulated, encoded, etc. In such an example, the communication circuitry 1330 may control a multiplexer to test the quality of the test signal on each of line of a 3-phase power cable or combinations of lines of a 3-phase power cable (e.g., where the test signal or information carried therein is known). Based on the quality (e.g., per one or more quality control metrics), the communication circuitry 1330 may control the multiplexer to receive signals via one or more lines of the 3-phase power cable. As an example, such a test may optionally provide information germane as to power quality, transmission quality, etc., for providing DC power to one or more pieces of downhole equipment (e.g., one or more sensors, etc.).

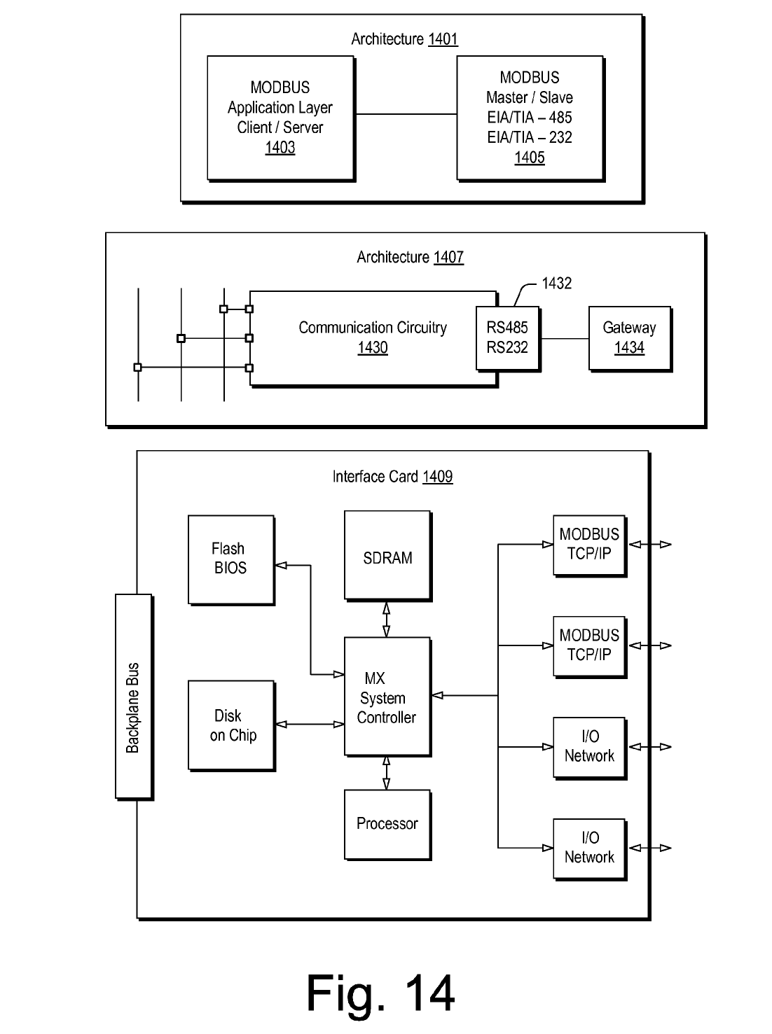

FIG. 14 shows an example of an architecture 1401, an example of an architecture 1407 and an example of an interface card 1409. As shown, the architecture 1401 may implement a MODBUS™ specification. For example, consider an application layer 1403 that links to a master / slave layer 1405.

As an example, a master-slave type of system can include a node (the master node) that issues commands to one of the slave nodes and processes responses. As an example, a slave node may transmit data upon receipt of a request from the master node. At a physical level, MODBUS™ transmission over serial line systems may use one or more types of physical interfaces (e.g., RS485, RS232, etc.). As an example, consider a TIA/EIA-485 (RS485), which may be implemented as a two-wire interface; noting that as an option, a RS485 four-wire interface may be implemented. As another example, consider a TINEIA-232-E (RS232) serial interface, which may be used as an interface (e.g., shorter point to point communication).

As to the architecture 1407, as shown, communication circuitry 1430 as including one or more interfaces 1432 (e.g., RS485 and/or RS232 interfaces), which may be operatively coupled to a gateway 1434. As an example, the gateway 1434 may be operatively coupled to circuitry such as circuitry of the interface card 1409.

As shown in the example of FIG. 14, the interface card 1409 can include one or more TCP/IP ports, one or more network I/O ports, etc. As shown, the interface card 1409 includes a multiplexer, a processor and memory. The multiplexer may be operable via execution of instructions stored in memory (e.g., flash, SDRAM, disk on chip, etc.) that may be executable by the processor. For example, the multiplexer may be controlled to receive signals via the one or more ports. As an example, the interface card 1409 may include a backplane bus, for example, to communication information received via the one or more ports.

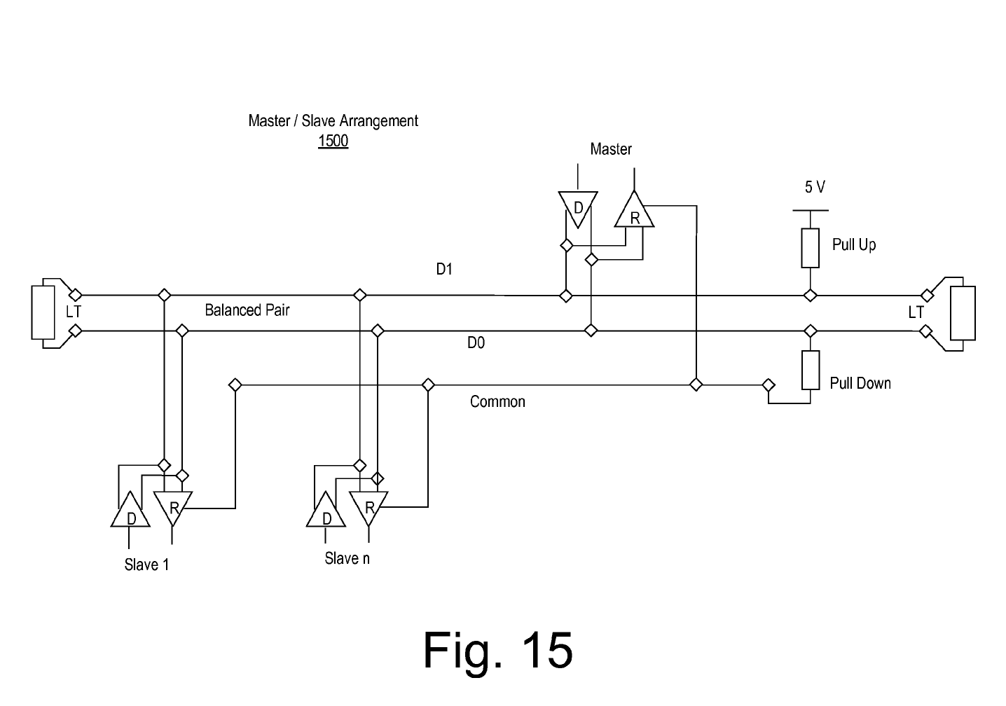

FIG. 15 shows an example of a master / slave arrangement of circuitry 1500 that includes a plurality of slaves. As an example, such circuitry may include slaves that correspond to sensor units, for example, as operatively coupled to motors that are powered by a common multiphase power cable. As an example, communication circuitry such as the circuitry 1430 may “break-out” sensor unit signals from a plurality of sensor units operatively coupled to a common cable. Such broken out signals may be considered slave signals that can be carried via a multi-wire bus. Such a bus may optionally be coupled to a gateway and, for example, to an interface card, which may include one or more TCP/IP ports. As an example, communication circuitry may break-out sensor unit signals to separate ports where, for example, the separate ports may be operatively coupled to respective individual ports of an interface card.

As an example, an interface card may be part of a controller. For example, the UNICONN™ controller may include an interface card (e.g., or interface cards) that may be configured to receive signals from a plurality of sensor units that are operatively coupled to motors that are powered by a common cable. As an example, a system may include an INSTRUCT™ acquisition and control unit that includes one or more interface cards that may be configured to receive signals from a plurality of sensor units that are operatively coupled to motors that are powered by a common cable.

As an example, a portion of a communication link for a plurality of sensor units may be via a MODBUS™ system where, for example, slaves are connected (e.g., in parallel) on a trunk cable that may include three or more conductors. For example, for a three conductor arrangement, two of the conductors (e.g., a “two-wire” configuration) may form a balanced twisted pair, on which bi-directional data may be transmitted (e.g., consider a bit rate of about 9600 bits per second).

As mentioned, a gateway may be included in a system. For example, MODBUS™ TCP/IP is a MODBUS™ protocol with a TCP wrapper. In such an example, a gateway may be implemented to convert from a current physical layer (RS232, RS485 or other) to Ethernet and, for example, to convert MODBUS™ protocol to MODBUS™ TCP/IP.

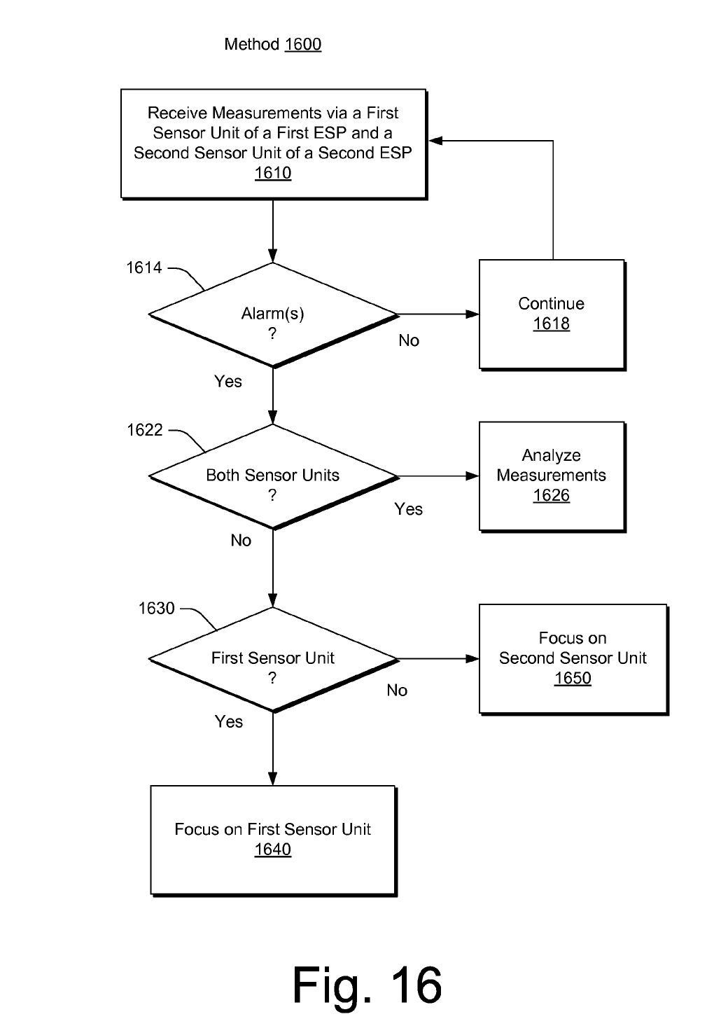

FIG. 16 shows an example of a method 1600 that includes a reception block 1610 for receiving measurements via a first sensor unit of a first ESP and a second sensor unit of a second ESP, and a decision block 1614 for deciding whether an alarm exists based at least in part on a portion of the received measurements. As shown, if an alarm does not exist, the method 1600 proceeds to a continuation block 1618 that can continue to the reception block 1610. However, if an alarm exists, the method 1600 proceeds to a decision block 1622 for deciding whether an alarm (e.g., or alarms) exists for both sensor units. As shown, where both sensor units are in an alarm state, the method 1600 can continue to an analysis block 1626 for analyzing measurements, for example, as to commonalities, differences, etc. In such an example, appropriate action may be taken as to one or both of the ESPs. However, where both sensor units are not involved, the method 1600 proceeds to a decision block 1630 for deciding whether an alarm exists for the first sensor unit. Depending on the decision made, the method 1600 will continue to a focus block 1640 for focusing on measurements of the first sensor unit or to a focus block 1650 for focusing on measurements of the second sensor unit. As an example, a focus block may cause a system to ignore measurements from the other sensor unit, to increase a data transmission rate of a sensor unit, etc.

As an example, where a one of two sensor units transmits one or more measurements that trigger an alarm, transmission rate (e.g., bits per minute), transmission quality (e.g., bit depth), etc., of measurements for that sensor unit may be increased. For example, two sensor units on a common power cable may transmit measurements at a rate (e.g., or data quality) less than one sensor unit. However, if an issue arises as to a motor, a pump, etc. associated with one of the sensor units, then a maximum rate (e.g., or data quality) may be implemented for that sensor unit, optionally shutting down transmission of measurements from the other sensor unit, at least on a temporary basis.

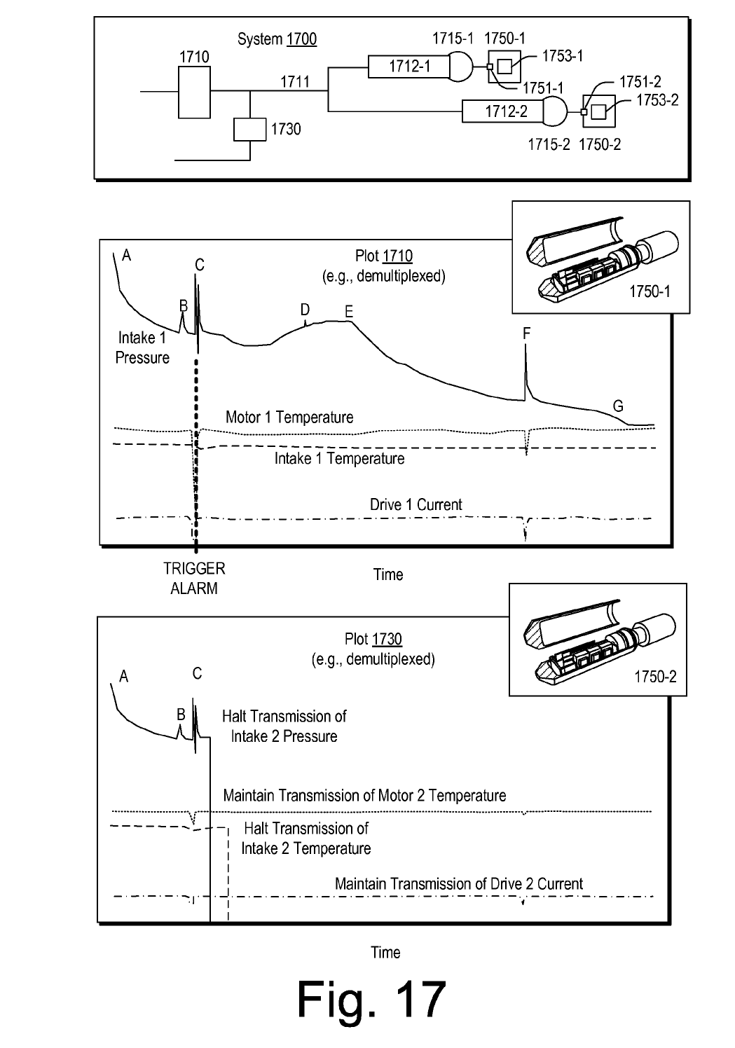

FIG. 17 shows an example of a system 1700, an example plot 1710 of measurements versus time for a first sensor unit (Unit 1) operatively coupled to a first ESP and an example plot 1730 of measurements versus time for a second sensor unit (Unit 2) operatively coupled to a second ESP.

As shown, the system 1700 includes a first electric submersible pump 1712-1 that includes an electric motor 1715-1 with a wye point and a sensor unit 1750-1 coupled to the wye point via a wye point interface 1751-1; a second electric submersible pump 1712-2 that includes an electric motor 1715-2 with a wye point and a sensor unit 1750-2 coupled to the wye point via a wye point interface 1751-2; a multiphase power cable 1711 operatively coupled to a power supply 1710 and operatively coupled to the electric motor 1715-1 of the first electric submersible pump 1712-1 and operatively coupled to the electric motor 1715-2 of the second electric submersible pump 1712-2; and communication circuitry 1730 operatively coupled to the multiphase power cable 1711 where the communication circuitry 1730 receives signals carried by the multiphase power cable 1711 as transmitted by the sensor unit 1750-1 of the first electric submersible pump 1712-1 and as transmitted by the sensor unit 1750-2 of the second electric submersible pump 1712-2.

In the example of FIG. 17, the sensor units 1750-1 and 1750-2 include multiplexing circuitry 1753-1 and 1753-2, for example, operatively coupled to their respective wye point interfaces 1751-1 and 1751-2. In such an example, the multiplexing circuitry 1753-1 and 1753-2 can multiplex sensor signals according to a multi-sensor unit multiplexing scheme. For example, consider a multi-sensor unit time based multiplexing scheme and/or a multi-sensor unit frequency based multiplexing scheme. As an example, each of the sensor units 1750-1 and 1750-2 can include sensors where, for example, the multiplexing circuitry 1753-1 and 1753-2 multiplexes signals of each of the sensors according to a multi-sensor unit multiplexing scheme with respect to signals of sensors of another sensor unit (e.g., the sensor unit 1750-1 with respect to the sensor unit 1750-2 and vice versa).

As an example, a distance between the first electric submersible pump 1712-1 and the second electric submersible pump 1712-2 may be about one hundred meters or less. In such an example, where the pumps 1712-1 and 1712-2 are in fluid communication, for example, as to inlets, outlets, outlet of one to inlet of the other, etc., fluid mechanics and operation associated with one of the pumps 1712-1 and 1712-2 may have an influence on fluid mechanics and operation associated with the other of the pumps 1712-1 and 1712-2. As an example, the system 1700 may be considered to include or be a power cable based multi-sensor unit signal transmission system.

In the example plots 1710 and 1730, as the first and second ESPs 1712-1 and 1712-2 may be in fluid communication (see, e.g., FIG. 5), intake pressures may correspond to conditions seen by both ESPs 1712-1 and 1712-2, however, the motor temperature for the motor 1715-1 of the first ESP 1712-1 experiences a spike, which may indicate an issue as to that ESP 1712-1. In such an example, one or more of the measurements of the second sensor unit 1750-2 may be halted or otherwise diminished, for example, to focus on measurements of the first sensor unit 1750-1. For example, where a data rate is reduced from a maximum data rate due in part to transmission of signals from two separate sensor units via a common power cable, a signal, command, etc., may be issued to one of the sensor units to reduce one or more of transmission rate, transmission quality, etc.

As shown in the plot 1730, due to an alarm being triggered as to measurement(s) of the first sensor unit 1750-1, transmission of intake 2 pressure and intake 2 temperature are halted while transmission of motor 2 temperature and drive 2 current are maintained. As an example, upon resolution of an issue, a transmission state may be restored or otherwise adjusted.

As an example, a system can include state logic that can include alarm states where an alarm state may call for reconfiguring transmission of information from one or more sensor units that are operatively coupled to a common power cable that powers two or more ESPs.

As an example, a system can include a first electric submersible pump (ESP) that includes an electric motor with a wye point and sensor circuitry coupled to the wye point; a second electric submersible pump (ESP) that includes an electric motor with a wye point and sensor circuitry coupled to the wye point; a multiphase power cable operatively coupled to the electric motor of the first ESP and operatively coupled to the electric motor of the second ESP; and a choke operatively coupled to the multiphase power cable for receipt of signals transmitted from the sensor circuitry of the first ESP and for receipt of signals transmitted from the sensor circuitry of the second ESP.

As an example, a method can include transmitting a signal from a first ESP via a wye point of an electric motor to a multiphase power cable; transmitting a signal from a second ESP via a wye point of an electric motor to the multiphase power cable; and receiving the transmitted signals via a choke operatively coupled to the multiphase power cable. As an example, a method may include transmitting a signal from a first ESP and transmitting a signal from a second ESP using multiplexing. As an example, a method may include transmitting a signal from a first ESP and transmitting a signal from a second ESP using frequency-based coding and/or time-based coding.

As an example, a system can include a first electric submersible pump that includes an electric motor with a wye point and a sensor unit coupled to the wye point; a second electric submersible pump that includes an electric motor with a wye point and a sensor unit coupled to the wye point; a multiphase power cable operatively coupled to the electric motor of the first electric submersible pump and operatively coupled to the electric motor of the second electric submersible pump; and communication circuitry that can include a choke operatively coupled to the multiphase power cable that receives signals transmitted by the sensor unit of the first electric submersible pump and that receives signals transmitted by the sensor unit of the second electric submersible pump. In such an example, the signals transmitted by the sensor unit of the first electric submersible pump and the signals transmitted by the sensor unit of the second electric submersible pump can be multiplexed. For example, consider the signals multiplexed via a time based multiplexing technique and/or the signals multiplexed via a frequency based multiplexing technique.

As an example, signals transmitted by a sensor unit of a first electric submersible pump can include a first signal frequency and signals transmitted by a sensor unit of a second electric submersible pump can include a second signal frequency where the first signal frequency and the second signal frequency differ. For example, the first signal frequency and the second signal frequency can be frequencies of a frequency domain multiplexing technique.

As an example, a sensor unit may include one or more temperature sensors, one or more pressure sensors, etc.

As an example, a system can include a junction box operatively coupled to a multiphase power cable and operatively coupled a first power cable operatively coupled to an electric motor of a first electric submersible pump and operatively coupled to a second power cable operatively coupled to an electric motor of a second electric submersible pump.

As an example, a method can include transmitting a signal from a sensor unit of a first electric submersible pump via a wye point of an electric motor to a multiphase power cable; transmitting a signal from a sensor unit of a second electric submersible pump via a wye point of an electric motor to the multiphase power cable; and receiving the transmitted signals via a choke operatively coupled to the multiphase power cable. In such an example, the transmitting a signal from the sensor unit of the first electric submersible pump and the transmitting a signal from the sensor unit of the second electric submersible pump can include multiplexing. As an example, transmitting a signal from the sensor unit of the first electric submersible pump and transmitting a signal from the sensor unit of the second electric submersible pump can include time based multiplexing and/or frequency based multiplexing.

As an example, a method can include analyzing at least one of a multiplexed signal with respect to an alarm criterion. For example, such an alarm criterion can depend at least in part on a signal of a sensor unit of a first electric submersible pump and at least in part on a signal of a sensor unit of a second electric submersible pump.

As an example, a method may include triggering an alarm based at least in part on analyzing one or more multiplexed signals of a plurality of sensor units operatively coupled to a common power cable and, responsive to the alarm, adjusting a multiplexing technique. For example, such a method may adjust a data rate parameter, a data quality parameter, a multiplexing parameter, etc. Such a method may aim to increase rate and/or quality of data (e.g., measurements) from a particular sensor unit, for example, where an issue may exist as to an electronic submersible pump to which that sensor unit is operatively coupled.

As an example, a sensor unit can include a wye point interface; and multiplexing circuitry operatively coupled to the wye point interface where the multiplexing circuitry multiplexes sensor signals according to a multi-sensor unit multiplexing scheme. In such an example, the multi-sensor unit multiplexing scheme may be a time based multiplexing scheme and/or a frequency based multiplexing scheme.

As an example, a sensor unit can include sensors and multiplexing circuitry that multiplexes signals of each of the sensors according to a multi-sensor unit multiplexing scheme with respect to signals of sensors of another sensor unit.

As an example, one or more methods described herein may include associated computer-readable storage media (CRM) blocks. Such blocks can include instructions suitable for execution by one or more processors (or cores) to instruct a computing device or system to perform one or more actions.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

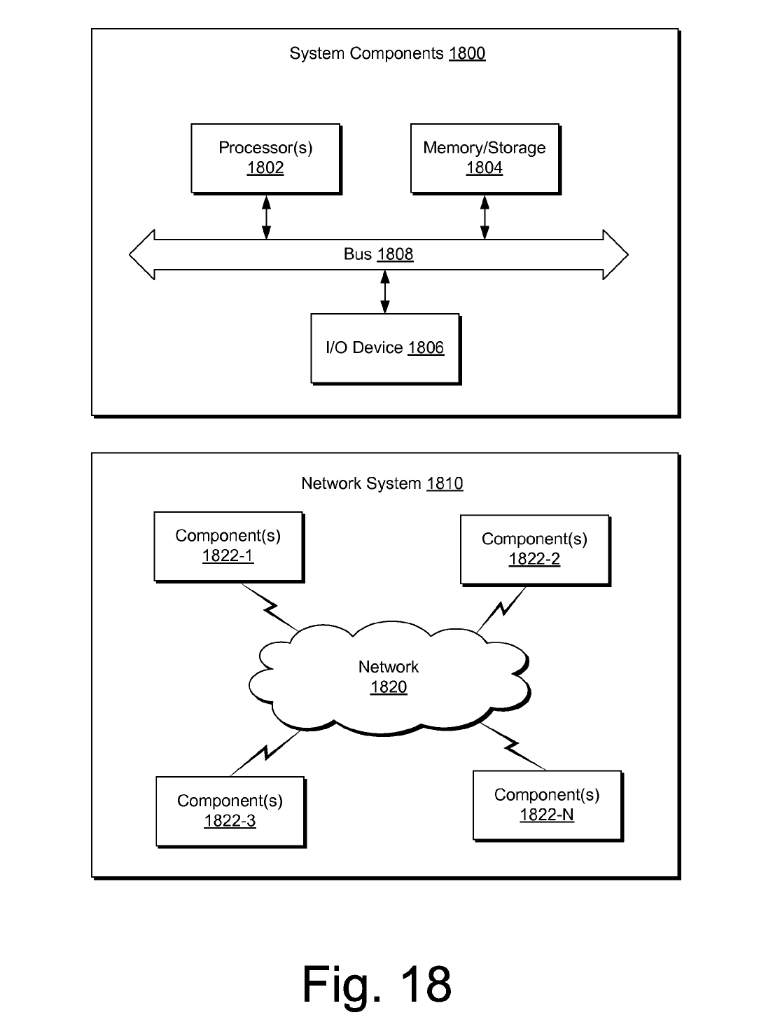

FIG. 18 shows components of a computing system 1800 and a networked system 1810. The system 1800 includes one or more processors 1802, memory and/or storage components 1804, one or more input and/or output devices 1806 and a bus 1808. According to an embodiment, instructions may be stored in one or more computer-readable media (e.g., memory/storage components 1804). Such instructions may be read by one or more processors (e.g., the processor(s) 1802) via a communication bus (e.g., the bus 1808), which may be wired or wireless. The one or more processors may execute such instructions to implement (wholly or in part) one or more attributes (e.g., as part of a method). A user may view output from and interact with a process via an I/O device (e.g., the device 1806). According to an embodiment, a computer-readable medium may be a storage component such as a physical memory storage device, for example, a chip, a chip on a package, a memory card, etc.

According to an embodiment, components may be distributed, such as in the network system 1810. The network system 1810 includes components 1822-1, 1822-2, 1822-3, . . . 1822-N. For example, the components 1822-1 may include the processor(s) 1802 while the component(s) 1822-3 may include memory accessible by the processor(s) 1802. Further, the component(s) 1802-2 may include an I/O device for display and optionally interaction with a method. The network may be or include the Internet, an intranet, a cellular network, a satellite network, etc.

Conclusion

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A system comprising:
a first electric submersible pump that comprises an electric motor with a wye point and a sensor unit coupled to the wye point;
a second electric submersible pump that comprises an electric motor with a wye point and a sensor unit coupled to the wye point;
a multiphase power cable operatively coupled to the electric motor of the first electric submersible pump and operatively coupled to the electric motor of the second electric submersible pump; and
communication circuitry that comprises a choke operatively coupled to the multiphase power cable that receives signals transmitted by the sensor unit of the first electric submersible pump and that receives signals transmitted by the sensor unit of the second electric submersible pump.

2. The system of claim 1 wherein the signals transmitted by the sensor unit of the first electric submersible pump and the signals transmitted by the sensor unit of the second electric submersible pump are multiplexed.

3. The system of claim 2 wherein the signals are multiplexed via a time based multiplexing technique.

4. The system of claim 2 wherein the signals are multiplexed via a frequency based multiplexing technique.

5. The system of claim 1 wherein the signals transmitted by the sensor unit of the first electric submersible pump comprise a first signal frequency and the signals transmitted by the sensor unit of the second electric submersible pump comprise a second signal frequency wherein the first signal frequency and the second signal frequency differ.

6. The system of claim 5 wherein the first signal frequency and the second signal frequency are frequencies of a frequency domain multiplexing technique.

7. The system of claim 1 the sensor units comprise temperature sensors.

8. The system of claim 1 the sensor units comprise pressure sensors.

9. The system of claim 1 further comprising a junction box operatively coupled to the multiphase power cable and operatively coupled a first power cable operatively coupled to the electric motor of the first electric submersible pump and operatively coupled to a second power cable operatively coupled to the electric motor of the second electric submersible pump.

10. A method comprising:
transmitting a signal from a sensor unit of a first electric submersible pump via a wye point of an electric motor to a multiphase power cable;
transmitting a signal from a sensor unit of a second electric submersible pump via a wye point of an electric motor to the multiphase power cable; and
receiving the transmitted signals via a choke operatively coupled to the multiphase power cable.

11. The method of claim 10 wherein the transmitting a signal from the sensor unit of the first electric submersible pump and the transmitting a signal from the sensor unit of the second electric submersible pump comprise multiplexing.

12. The method of claim 10 wherein the transmitting a signal from the sensor unit of the first electric submersible pump and the transmitting a signal from the sensor unit of the second electric submersible pump comprise frequency based multiplexing.

13. The method of claim 10 wherein the transmitting a signal from the sensor unit of the first electric submersible pump and the transmitting a signal from the sensor unit of the second electric submersible pump comprise time based multiplexing.

14. The method of claim 10 further comprising analyzing at least one of the signals with respect to an alarm criterion.

15. The method of claim 14 wherein the alarm criterion depends at least in part on the signal of the sensor unit of the first electric submersible pump and at least in part on the signal of the sensor unit of the second electric submersible pump.

16. The method of claim 14 further comprising triggering an alarm based at least in part on the analyzing and, responsive to the alarm, adjusting a multiplexing technique.

17. A sensor unit comprising:
a wye point interface; and
multiplexing circuitry operatively coupled to the wye point interface wherein the multiplexing circuitry multiplexes sensor signals according to a multi-sensor unit multiplexing scheme.

18. The sensor unit of claim 17 wherein the multi-sensor unit multiplexing scheme comprises a time based multiplexing scheme.

19. The sensor unit of claim 17 wherein the multi-sensor unit multiplexing scheme comprises a frequency based multiplexing scheme.

20. The sensor unit of claim 17 wherein the sensor unit comprises sensors and wherein the multiplexing circuitry multiplexes signals of each of the sensors according to a multi-sensor unit multiplexing scheme with respect to signals of sensors of another sensor unit.
